(19) United States
(12) Patent Application Publication
(10) Pub. No.: US 2014/0281316 A1
(43) Pub. Date: Sep. 18, 2014

(54) DATA MANAGEMENT DEVICE AND METHOD FOR COPYING DATA

(71) Applicant: FUJITSU LIMITED, Kawasaki-shi (JP)

(72) Inventor: Koji SANO, Kawasaki (JP)

(73) Assignee: FUJITSU LIMITED, Kawasaki-shi (JP)

(21) Appl. No.: 14/281,960

(22) Filed: May 20, 2014

Related U.S. Application Data
(63) Continuation of application No. PCT/JP2011/077536, filed on Nov. 29, 2011.

(51) Int. Cl. G06F 11/14

(52) U.S. Cl. CPC G06F 11/1451
USPC 711/162; 714/6.2

(57) ABSTRACT

In response to a first copy command, a first copying unit writes a first dataset read out of a volatile storage device into a first continuous area and a fourth continuous area, as well as a second dataset read out of the volatile storage device into a second continuous area and a third continuous area. In response to a second copy command, a second copying unit reads the first dataset out of the first continuous area by making sequential access thereto, in parallel with the second dataset out of the third continuous area by making sequential access thereto. The second copying unit writes the first dataset and second dataset back into the volatile storage device.

### CROSS-REFERENCE TO RELATED APPLICATION

This application is a continuation application of International Application PCT/JP2011/077536 filed on Nov. 29, 2011 which designated the U.S., the entire contents of which are incorporated herein by reference.

### FIELD

The embodiments discussed herein relate to a data management device and a method for copying data.

### BACKGROUND

Volatile storage devices are used in a variety of electronic appliances. Computers, for example, contain dual in-line memory modules (DIMM) and other types of volatile storage devices as their main memory. Cluster computing systems also contain volatile storage devices in their system storage unit (SSU) to store data that can be shared by a plurality of central processing units (CPU) in the system.

Some of those electronic appliances are equipped with an uninterruptible power supply (UPS) that provides emergency power for a certain period of time when the input power supply fails due to a main power outage, for example. Such a UPS-powered appliance protects data stored in its volatile storage devices by saving it into non-volatile storage devices during the period in which the UPS supplies electric power. Non-volatile storage devices for this purpose are, for example, solid-state drives (SSD) and hard disk drives (HDD). The data saved in such non-volatile storage devices is written back to the volatile storage devices, so that the appliance recovers from power failure and restarts its operation with the original data restored in volatile storage devices.

For a higher reliability of data saving, there is proposed a method for saving and restoring memory content using two storage devices. According to this method, a computer's storage space is divided into several segments, and the data stored in each segment is saved into a first non-volatile storage device and a second non-volatile storage device in a redundant way. See, for example, Japanese Laid-open Patent Publication No. 4-346144.

It is noted here that non-volatile storage devices for data saving is generally slower than volatile storage devices such as DIMMs in terms of the data read speed. This means that it takes a long time to restore data from non-volatile storage devices back to volatile storage devices.

As mentioned above, the reliability of data saving may be improved by using dual-redundant non-volatile storage devices to save data of volatile storage devices. Data is saved in this case by writing output data words of volatile storage devices to a plurality of non-volatile storage devices in the order that they are read out. The saved data is then read out of a non-volatile storage device for restoration to the volatile storage devices. This data restoration process takes time because it has to read the entire data from one non-volatile storage device at a relatively low speed. It may also be possible to reconstruct the original data from a collection of partial data in a plurality of non-volatile storage devices. This alternative method involves random access to non-volatile storage devices, which is slower than sequential access.

As seen from the above discussion, it is a time-consuming process to restore data from non-volatile storage devices to volatile storage devices. This results in a longer recovery time from power fault in the foregoing example of electronic appliances.

### SUMMARY

According to an aspect of the embodiments discussed herein, there is provided a data management apparatus including a volatile storage device; a first non-volatile storage device whose storage space includes first and second continuous areas each being sequentially accessible; a second non-volatile storage device whose storage space includes third and fourth continuous areas each being sequentially accessible; and a processor. The processor is configured to perform a procedure including: dividing, in response to a first copy command, data in the volatile storage device into a first dataset and a second dataset; reading the first dataset and second dataset out of the volatile storage device; writing the first dataset read out of the volatile storage device into the first continuous area and the fourth continuous area, and the second dataset read out of the volatile storage device into the second continuous area and the third continuous area; reading, in response to a second copy command, the first dataset out of the first continuous area by making sequential access to the first non-volatile storage device, in parallel with the second dataset out of the third continuous area by making sequential access to the second non-volatile storage device; and writing the first dataset read out of the first continuous area, as well as the second dataset read out of the third continuous area, into the volatile storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 exemplifies a functional structure of a data management apparatus according to a first embodiment;

FIG. 2 exemplifies a system configuration according to a second embodiment;

FIG. 3 exemplifies a hardware configuration of devices constituting the system;

FIG. 4 exemplifies an internal structure of a memory control circuit, particularly for its data save and restore functions;

FIG. 5 illustrates data that is saved and restored under the control of the memory control circuit;

FIG. 6 exemplifies how data blocks are saved;

FIG. 7 exemplifies how data blocks are saved in the case of a single DIMM configuration;

FIG. 8 is a timing diagram exemplifying a data saving process;

FIG. 9 exemplifies an arrangement of data saved in SSDs;

FIG. 10 exemplifies circuit blocks for data saving functions of a memory control circuit;

FIG. 11 is a flowchart illustrating an example of DIMM data read operations according to the second embodiment;

FIG. 12 is a flowchart illustrating an example of SSD data write operations according to the second embodiment;

FIG. 13 is a timing diagram illustrating an example of a data restoration process according to the second embodiment;

FIG. 14 exemplifies circuit blocks for data restoration functions of a memory control circuit;

FIG. 15 is a flowchart illustrating an example of SSD data read operations according to the second embodiment;

FIG. 16 is a flowchart illustrating an example of DIMM data write operations according to the second embodiment;

FIG. 17 is a flowchart of a restoration error recovery process according to the second embodiment;

FIG. 18 illustrates an example of data saving and data restoration processes for comparison with the second embodiment;

FIG. 19 is a block diagram illustrating an example of data saving functions of a memory control circuit according to a third embodiment;

FIG. 20 is a flowchart illustrating an example of DIMM data read operations according to the third embodiment;

FIG. 21 is a flowchart illustrating an example of SSD data write operations according to the third embodiment;

FIG. 22 is a block diagram illustrating an example of data restoration functions of the memory control circuit according to the third embodiment;

FIG. 23 is a flowchart illustrating an example of SSD data read operations according to the third embodiment;

FIG. 24 is a flowchart illustrating an example of DIMM data write operations according to the third embodiment;

FIG. 25 illustrates data that is saved and restored according to a fourth embodiment;

FIG. 26 is a flowchart illustrating an example of SSD data write operations according to the fourth embodiment;

FIG. 27 is a flowchart illustrating an example of SSD data read operations executed as part of a data restoration process according to the fourth embodiment;

FIG. 28 is a flowchart of a restoration error recovery process according to the fourth embodiment; and

FIG. 29 exemplifies a hardware configuration of a computer.

### DESCRIPTION OF EMBODIMENTS

Several embodiments will be described below with reference to the accompanying drawings. The embodiments may be combined with each other, unless they have contradictory features.

### (a) First Embodiment

This section describes a first embodiment, which is directed to a data management apparatus having a plurality of non-volatile storage devices to provide dual-redundant protection for data stored in volatile storage devices. The first embodiment is designed to divide the data into halves and save the two halves of data into sequentially-accessible storage areas in each of the dual-redundant non-volatile storage devices, so that the saved data can be restored into the volatile storage devices in a shorter time.

FIG. 1 exemplifies a functional structure of a data management apparatus according to the first embodiment. The illustrated data management apparatus 1 includes a volatile storage device 2, a first non-volatile storage device 3, a second non-volatile storage device 4, a first copying unit 5, and a second copying unit 6. The volatile storage device 2 may be formed from, for example, random access memory (RAM) devices. The first non-volatile storage device 3 may be formed from, for example, one or more SSDs or hard disk drives (HDDs). The first non-volatile storage device 3 has a larger storage capacity than the volatile storage device 2 and offers a first continuous area 3a and a second continuous area 3b, each of which is sequentially accessible. For example, the first continuous area 3a is a continuous storage space beginning at the topmost end of the storage space of the first non-volatile storage device 3. The second continuous area 3b is also a continuous storage space in the first non-volatile storage device 3 that immediately follows the first continuous area 3a.

Similarly to the first non-volatile storage device 3, the second non-volatile storage device 4 may be formed from one or more SSDs or HDDs with a larger storage capacity than the volatile storage device 2. The second non-volatile storage device 4 offers a third continuous area 4a and a fourth continuous area 4b, each of which is sequentially accessible. For example, the third continuous area 4a is a continuous storage space beginning at the topmost end of the storage space of the second non-volatile storage device 4. The fourth continuous area 4b is another continuous storage space in the second non-volatile storage device 4 that immediately follows the third continuous area 4a.

Each of the above sequentially-accessible, continuous storage areas 3a, 3b, 4a, and 4b is mapped on successive addresses and can therefore be read or written by using a sequential access method. In other words, data in these areas is accessed by simply incrementing the address. The first continuous area 3a has half the storage capacity of the volatile storage device 2, as are the second to fourth continuous areas 3b, 4a, and 4b.

The first copying unit 5 reads two divided portions of data from the volatile storage device 2, which are referred to as a first dataset 7 and a second dataset 8. The first copying unit 5 performs this operation in response to a first copy command, which may actually be, for example, a save command used to preserve the data currently stored in the volatile storage device 2 by sending its copy to the first non-volatile storage device 3 and second non-volatile storage device 4. The first dataset 7 may be, for example, a set of data in a first memory module 2a in the volatile storage device 2. The second dataset 8 may be, for example, a set of data in a second memory module 2b in the volatile storage device 2. The first copying unit 5 reads out the first dataset 7 and writes it into the first continuous area 3a and fourth continuous area 4b. Similarly, the first copying unit 5 reads the second dataset 8 and writes it into the second continuous area 3b and third continuous area 4a.

The second copying unit 6 reads the first dataset out of the first continuous area 3a in parallel with the second dataset 8 out of the third continuous area 4a, both by using a sequential access method. The second copying unit 6 performs these parallel read operations in response to a second copy command, which may actually be, for example, a restore command used to restore the original data in the volatile storage device 2 by transferring the save data from the first and second non-volatile storage devices 3 and 4 back to the volatile storage device 2. The reading of the second dataset 8 begins at the topmost address of the third continuous area 4a.

The second copying unit 6 also writes the first dataset 7 and second dataset 8 to the volatile storage device 2. For example, the second copying unit 6 writes the first dataset 7 into first memory module 2a, and the second dataset 8 into the second memory module 2b.

In operation of the above data management apparatus 1, a first copy command causes the first copying unit 5 to read a first dataset 7 and a second dataset 8 out of the volatile storage device 2. The first copying unit 5 writes the first dataset 7 into first and fourth continuous areas 3a and 4b, as well as the second dataset 8 into second and third continuous areas 3b and 4a. Afterwards the data management apparatus 1 receives a second copy command. In response, the second copying unit 6 sequentially reads the first dataset 7 from the topmost address of first continuous area 3a, as well as the second dataset 8 from the topmost address of the third continuous area 4a. That is, a sequential read operation takes place in both the first continuous area 3a and third continuous area 4a. The second copying unit 6 writes the first dataset 7 and second dataset 8 into the volatile storage device 2.

As can be seen from the above description, the first embodiment is designed to use sequentially accessible, continuous storage areas for saving each dataset from the volatile storage device 2 to the first non-volatile storage device 3 and second non-volatile storage device 4 in a dual-redundant manner. This feature of the first embodiment permits the volatile storage device 2 to restore its original data through concurrent sequential read operations on two halves of the saved data, one half from the first non-volatile storage device 3 and the other half from the second non-volatile storage device 4. The data restoration time is thus reduced by about one half, relative to the case in which the two datasets are read out of one non-volatile storage device. This reduction of data restoration time enables, for example, a quick reboot of the system. The noted feature may be implemented in a computing system having a dual-redundant storage subsystem, without the need for adding an extra capacity to its non-volatile storage devices.

The above-described first copying unit 5 and second copying unit 6 may be implemented in a memory control circuit or other electronic circuits in the data management apparatus 1. It may also be possible to implement them by using one or more CPUs.

It is noted that the lines interconnecting functional blocks in FIG. 1 represent some of their communication paths. The person skilled in the art would appreciate that there may be other communication paths in actual implementations.

As described above, the first copying unit 5 saves data by writing it to the first non-volatile storage device 3 and second non-volatile storage device 4. This write operation is achieved in the way described below.

The first copying unit 5 has an address offset that is equivalent to one half or more of the storage capacity of the volatile storage device 2. The first copying unit 5 reads a first dataset 7 from the volatile storage device 2 and writes each read data word into the first non-volatile storage device 3, starting from the topmost address of the same. The first copying unit 5 also writes those data words to the second non-volatile storage device 4, but each with a write address obtained by adding the noted address offset to the write address used for the first non-volatile storage device 3.

The first copying unit 5 similarly reads a second dataset 8 from the volatile storage device 2 and writes each read data word into the second non-volatile storage device 4, starting from the topmost address of the same. The first copying unit 5 also writes these data words to the first non-volatile storage device 3, but each with a write address obtained by adding the address offset to the write address used for the second non-volatile storage device 4.

The above addressing control of the first embodiment enables writing data from the volatile storage device 2 to the first non-volatile storage device 3 and second non-volatile storage device 4.

It is noted here that the second copying unit 6 may encounter a read data error during its operation. When the detected error is uncorrectable, the second copying unit 6 may read the data in question from an alternative storage device storing a redundant copy of the data. For example, the second copying unit 6 handles such uncorrectable errors as follows.

When an uncorrectable error is found in a data word read out of the first non-volatile storage device 3, the second copying unit 6 records the local address of that data word in the first non-volatile storage device 3. This address is “local” because it only gives a relative displacement within the first non-volatile storage device 3. The second copying unit 6 calculates an alternative read address for the second non-volatile storage device 4 by adding the aforementioned address offset to the recorded local address. The second copying unit 6 then reads a data word from the second non-volatile storage device 4 by using the calculated alternative address.

When an uncorrectable error is found in a data word read out of the second non-volatile storage device 4, the second copying unit 6 records the local address of that data word within the second non-volatile storage device 4. The second copying unit 6 calculates an alternative read address for the first non-volatile storage device 3 by adding the aforementioned address offset to the recorded local address. The second copying unit 6 then reads a data word from the first non-volatile storage device 3 by using the calculated alternative address.

The second copying unit 6 deals with uncorrectable read data errors in the way described above, whether the error is found in the first non-volatile storage device 3 or in the second non-volatile storage device 4. The read operation of alternative data permits the second copying unit 6 to restore correct data in the volatile storage device 2.

### (b) Second Embodiment

This section describes a second embodiment, which is directed to data restoration from non-volatile storage devices to volatile storage devices in an SSU of a complex computer system. The SSU in the second embodiment is an example of the data management apparatus 1 discussed above in the first embodiment.

FIG. 2 exemplifies a system configuration according to the second embodiment. The illustrated complex computer system includes a cluster 200 and an SSU 100 connected thereto. The SSU 100 contains non-volatile storage devices such as SSDs to store data shared by a plurality of CPUs in the cluster 200.

FIG. 3 exemplifies a hardware configuration of devices constituting the system. The cluster 200 includes a plurality of CPUs 211, 212, and 213, a memory 220, and a system controller 230. The system controller 230 communicates with the SSU 100 to send and receive data. The SSU 100 includes DIMMs 111 and 112, SSDs 121 and 122, a memory control circuit 130, an interface circuit 101, a UPS control circuit 102, a UPS 103, and an SSU control circuit 104.

The DIMMs 111 and 112 (distinguished as “first DIMM” and “second DIMM” where appropriate) are volatile storage devices that store data used by the CPUs 211, 212, and 213 in the cluster 200. For example, each DIMM 111 and 112 includes RAM chips, a write counter, and a read counter. Each time a data write operation is finished in one DIMM 111 or 112, its write counter is incremented by a value equivalent to the amount of the written data. The incremented write counter points to the next address location in which a next data write operation is to take place. Similarly, each time a data read operation is finished in one DIMM 111 or 112, its read counter is incremented by a value equivalent to the amount of the read data. The incremented read counter points to the next address location in which a next data read operation is to take place.

The SSDs 121 and 122 (distinguished as “first SSD” and “second SSD” where appropriate) are non-volatile storage devices used for saving data stored in DIMMs 111 and 112. Each SSD 121 and 122 contains, for example, flash memory devices, a write counter, and a read counter. Each time a data write operation is done in one SSD 121 or 122, its write counter is incremented by a value corresponding to the amount of the written data. The incremented write counter points to the next address location in which a next data write operation is supposed to take place. Similarly, each time a data read operation is done in one SSD 121 or 122, its read counter is incremented by a value corresponding to the amount of the read data. The incremented read counter points to the next address location in which a next data read operation is supposed to take place.

The memory control circuit 130 controls input and output of data to and from DIMMs 111 and 112, as well as SSDs 121 and 122. For example, the memory control circuit 130 may receive write data from CPUs 211, 212, and 213 in the cluster 200 via the interface circuit 101. In response, the memory control circuit 130 writes the received data to the DIMMs 111 and 112. The memory control circuit 130 may also receive a read request from CPUs 211, 212, and 213 in the cluster 200 via the interface circuit 101. In response, the memory control circuit 130 reads requested data out of the DIMMs 111 and 112 and transfers it to the cluster 200.

The SSU 100 is normally powered by an external power supply 21. When the external power is lost for some reason, the UPS 103 starts to supply its stored electric power to the SSU 100. The memory control circuit 130 saves a copy of the current data in DIMMs 111 and 112 into SSDs 121 and 122 before the energy in the UPS 103 runs out. When the external power supply 21 comes back, the memory control circuit 130 restores the saved data in the SSDs 121 and 122 back to the DIMMs 111 and 112.

The interface circuit 101 is used for data communication between the SSU 100 and cluster 200. The UPS control circuit 102 controls operation related to the UPS 103, such as charging batteries. The UPS control circuit 102 also determines whether to select the external power supply 21 or UPS 103 as the main power source for the SSU 100. For example, the UPS control circuit 102 switches the power source from the external power supply 21 to the UPS 103 upon detection of power down, while informing the SSU control circuit 104 that the external power is lost. When the external power supply 21 recovers, the UPS control circuit 102 selects the external power supply 21 again and informs the SSU control circuit 104 of the recovery of external power.

The UPS 103 contains battery cells designed to be charged during a period when the external power supply 21 is alive. When the external power supply 21 is down, the UPS 103 supplies each circuit in the SSU 100 with electrical power from its internal batteries.

The SSU control circuit 104 controls operation of the SSU 100, including its power down and recovery procedures. For example, the SSU control circuit 104 may be informed from the UPS control circuit 102 that the external power supply 21 is lost or interrupted. In response, the SSU control circuit 104 sends the memory control circuit 130 a data save command for saving the current data in DIMMs 111 and 112. When the external power supply 21 recovers, the UPS control circuit 102 so informs the SSU control circuit 104. In response, the SSU control circuit 104 sends the memory control circuit 130 a data restore command for restoring the saved data back to the DIMMs 111 and 112.

As can be seen from the above description of the SSU 100, the data is saved from DIMMs 111 and 112 to SSDs 121 and 122 and restored back to the DIMMs 111 and 112 under the control of the memory control circuit 130. More details of data saving and restoring functions will be described below.

FIG. 4 exemplifies an internal structure of a memory control circuit, particularly its data save and restore functions. The illustrated memory control circuit 130 includes a memory configuration management circuit 131, a data saving circuit 132, and a data restoration circuit 133.

The memory configuration management circuit 131 manages the number of DIMMs 111 and 112 and the capacity of each individual DIMM 111 and 112. The memory configuration management circuit 131 also calculates a boundary address based on the total storage capacity of DIMMs 111 and 112 for use in saving their data into SSDs 121 and 122. For example, this boundary address is obtained by dividing the total storage capacity of DIMMs 111 and 112 by the number of SSDs 121 and 122. More specifically, each DIMM 111 and 112, as well as each SSD 121 and 122, offers an address space designated by a series of successively increasing numbers each representing a specific byte address. Since the number of SSDs 121 and 122 is two in the present example, the quotient of the total storage capacity (in bytes) of DIMMs 111 and 112 divided by two indicates an address immediately next to the topmost portion of SSD storage space whose size is equivalent to one DIMM.

The data saving circuit 132 saves data from DIMMs 111 and 112 to SSDs 121 and 122 in response to a data save command. For example, the data saving circuit 132 reads data out of DIMMs 111 and 112 and writes it to SSDs 121 and 122 such that two redundant copies of the data will be produced in the SSDs 121 and 122.

The data restoration circuit 133 restores the saved data in the SSDs 121 and 122 back to the DIMMs 111 and 112 in response to a data restore command. For example, the data restoration circuit 133 reads data out of the SSDs 121 and 122 and writes it to the DIMMs 111 and 112. More particularly, the data restoration circuit 133 reads one half of the saved data from the first SSD 121 and the other half from the second SSD 122 and restores these two halves in the two DIMMs 111 and 112, respectively.

As can be seen from the above, the SSU 100 saves and restores data under the control of its memory control circuit 130. It is noted that the above-described data saving circuit 132 is an example of the first copying unit 5 discussed previously in FIG. 1 for the first embodiment, and that the data restoration circuit 133 is an example of the second copying unit 6 discussed in the same. It is also noted that the above-described boundary address is an example of the address offset discussed previously in the first embodiment.

FIG. 5 illustrates data that is saved and restored under the control of the memory control circuit 130. In this example of FIG. 5, two DIMMs 111 and 112 have equal storage capacities, and each SSD 121 and 122 has twice the storage capacity of one DIMM. The two DIMMs 111 and 112 are identified by their respective identifiers “DIMM-A” and “DIMM-B.” The two SSDs 121 and 122 are identified by their respective identifiers “SSD-A” and “SSD-B.”

During the course of data saving, data read out of the first DIMM 111 is temporarily stored in a buffer 134 in the memory control circuit 130 before it is sent to the SSDs 121 and 122. The data read out of the first DIMM 111 is written via this buffer 134 to an upper area 121a of the first SSD 121, as well as to a lower area 122b of the second SSD 122 as seen in FIG. 5, thus producing two redundant copies of DIMM data in these SSDs 121 and 122.

Similarly to the above, data read out of the second DIMM 112 is temporarily stored in another buffer 135 in the memory control circuit 130, before it is sent to the SSDs 121 and 122. The data is written via this buffer 135 to a lower area 121b of the first SSD 121, as well as to an upper area 122a of the second SSD 122 as seen in FIG. 5, thus producing two redundant copies of DIMM data in these SSDs 121 and 122.

In a data restoration process, one half of the saved data is read out of the upper area 121a of the first SSD 121 and temporarily stored into the buffer 134. This data in the buffer 134 is then written into the first DIMM 111. Similarly, the other half of the saved data is read out of the upper area 122a of the second SSD 122 and temporarily stored into the buffer 135. This data in the buffer 135 is then written into the second DIMM 112.

The data is restored in the DIMMs 111 and 112 through a sequential read operation on the upper area (or the first half) 121a and 122a of each SSD 121 and 122. This data restoration process is finished in about half the time consumed to read the same amount of data from one SSD 121 and 122.

While not depicted in FIG. 5, the data words stored in DIMMs 111 and 112 are added an error correcting code (ECC) for checking and correcting a possible error. Also, the SSDs 121 and 122 add a cyclic redundancy check (CRC) code to each set of write data and check the integrity of data when it is read out.

According to the second embodiment, the storage space of DIMMs 111 and 112 is divided into a plurality of blocks with a data size of 512 bytes, for example. Data saving and restoration is performed on a block-by-block basis. The term “data block” will now be used to refer to such a block of data.

FIG. 6 exemplifies how data blocks are saved. It is assumed in this example of FIG. 6 that each DIMM 111 and 112 has a storage capacity of 4 gigabytes (GB) while each SSD 121 and 122 has a storage capacity of 8 GB. The storage space of the first SSD 121 is divided into two areas with a size of 4 GB, which is half the total storage capacity (8 GB) of the DIMMs 111 and 112. The storage space of the second SSD 122 is also divided into two 4-GB areas. The leading 4-GB area is referred to as an “upper area,” and the subsequent 4-GB area is referred to as a “lower area.” The beginning address of the lower area is referred to as a “boundary address.” In the example of FIG. 6, individual data blocks are designated by alphabetical letters “A” to “Z” for illustrative purposes.

Data block A is at the topmost storage location in the first DIMM 111, whose copies are saved at the topmost end of the upper area of the first SSD 121 and at the topmost end of the lower area of the second SSD 122. Subsequent data blocks C, E, G, . . . in the first DIMM 111 follow the data block A in each SSD 121 and 122. Likewise, data block B is at the topmost storage location in the second DIMM 112, whose copies are saved at the topmost end of the lower area of the first SSD 121 and at the topmost end of the upper area of the second SSD 122. Subsequent data blocks D, F, H, in the second DIMM 112 follow the data block B in each SSD 121 and 122.

Since data blocks are saved in this way, the original data can be reconstructed in the DIMMs 111 and 112 by restoring data blocks from the upper area of the first SSD 121 to the first DIMM 111, as well as from the upper area of the second SSD 122 to the second DIMM 112. That is, two sequential read operations run in parallel to read data blocks from the upper area of each SSD 121 and 122, thus achieving high-speed data restoration.

It is noted that the SSDs 121 and 122 contain saved data in a particular form that is not affected by the number of DIMMs. While the SSU 100 discussed in FIGS. 3 to 6 has two DIMMs 111 and 112, it is possible to modify this SSU 100 with a single DIMM configuration. As will be described below, the data blocks in this single DIMM are distributed to the upper and lower areas of each SSD in an alternating fashion.

FIG. 7 exemplifies how data is saved in the case of a single DIMM configuration. It is assumed in this example that 4-GB data in the single DIMM 111-1 is distributed to two SSDs 121-1 and 122-1 each having a capacity of 4 GB. Since the total DIMM capacity is 4 GB in this case, the boundary address is set to the point of 2 GB. That is, the leading 2-GB area of each SSD 121-1 and 122-1 is referred as the upper area, and the rest is referred to as the lower area.

Specifically, data block A is at the topmost storage location in the DIMM 111-1, whose copies are saved at the topmost end of the upper area of the first SSD 121-1, as well as at the topmost end of the lower area of the second SSD 122-1. Data block B is at the second storage location in the DIMM 111-1, whose copies are saved at the topmost end of the lower area of the first SSD 121-1, as well as at the topmost end of the upper area of the second SSD 122-1. Data block C in the DIMM 111-1 follows the data block A in each SSD 121-1 and SSD 122-1, and data block D in the DIMM 111-1 follows the data block B in each SSD 121-1 and 122-1.

As can be seen from the above example, the first SSD 121-1 stores DIMM data blocks alternately in its upper and lower areas, when the DIMM 111-1 is the only DIMM in the SSU 100. The second SSD 122-1 also stores those data blocks in a similar way, except that the second SSD 122-1 starts it from its lower area whereas the first SSD 121-1 starts it from its upper area. The illustrated arrangement of saved data blocks permits the SSU 100 to restore data in the DIMM 111-1 by sequentially reading data blocks from the upper area of each SSD 121-1 and 122-1.

(1) Data Saving Process

This subsection describes a detailed procedure of a data saving process, assuming a dual DIMM configuration similar to the one discussed in FIGS. 3 to 6. FIG. 8 is a timing diagram exemplifying a data saving process. The topmost part of FIG. 8 depicts read operations of data blocks from two DIMMs 111 and 112 labeled with their identifiers “DIMM-A” and “DIMM-B,” respectively. The lower part of FIG. 8 illustrates write operations of data blocks to two SSDs 121 and 122 labeled with their respective identifiers “SSD-A” and “SSD-B.”

The data saving process begins with parallel read operations at address block A of the first DIMM 111 (DIMM-A) and address block B of the second DIMM 112 (DIMM-B). Unless an error is found in the obtained data, a write operation takes place at address block A in the upper area of the first SSD 121 (SSD-A) in parallel with another write operation at address block B in the upper area of the second SSD 122 (SSD-B). This is followed by a write operation of address block A in the lower area of the second SSD 122 (SSD-B) in parallel with a write operation of address block B in the lower area of the first SSD 121 (SSD-A). The data saving process up to this point has saved two address blocks A and B in two redundant copies. Other data blocks are successively saved from each DIMM 111 and 112 to the SSDs 121 and 122 in a redundant way until the total storage capacity of the DIMMs 111 and 112 is covered.

Since DIMMs are faster than SSDs in general, there is a relatively long gap between each two successive DIMM read operations as seen in FIG. 8. In contrast, SSD write operations are finished before the next DIMM data is ready.

FIG. 9 exemplifies an arrangement of data saved in SSDs. Specifically, the first SSD 121 stores data in its upper area 121a in the same order of blocks as the original data in the first DIMM 111. The second SSD 122 also stores data in its upper area 122a in the same order of blocks as the original data in the second DIMM 112.

As seen in FIG. 9, the upper areas 121a and 122a of two SSDs 121 and 122 store the entire set of data saved from the DIMMs 111 and 112. It is therefore possible to restore the DIMM data solely from these upper areas 121a and 122a by starting sequential read operations from the topmost address of the SSDs 121 and 122. While the SSDs 121 and 122 can be read sequentially or randomly, sequential access is faster than random access. The data is stored in continuous areas as illustrated in FIG. 9 and thus suitable for high-speed sequential read operations.

As will be described below, the data saving functions are implemented in the memory control circuit 130. FIG. 10 exemplifies circuit blocks of the memory control circuit 130, which are largely divided into two parts: a memory configuration management circuit 131 and a data saving circuit 132.

The memory configuration management circuit 131 includes a register array 131a, a DIMM capacity calculation circuit 131b, and a boundary address calculation circuit 131c. The register array 131a is made up of a plurality of registers to store various parameters that represent, for example, the number of DIMMs mounted in the SSU 100 and the memory capacity of each DIMM. The memory control circuit 130 determines and registers such parameters in relevant registers in the register array 131a automatically at the time of starting up the SSU 100.

The DIMM capacity calculation circuit 131b calculates the total capacity of DIMMs. For example, the DIMM capacity calculation circuit 131b consults the register array 131a to obtain the individual memory capacities of DIMMs and adds up them. The boundary address calculation circuit 131c calculates a boundary address for use in saving data to SSDs 121 and 122. For example, the boundary address calculation circuit 131c divides the above total capacity of DIMMs by two and assigns the quotient as the boundary address.

The data saving circuit 132 includes (among others) a first buffer 134a and a second buffer 135a to temporarily store data blocks read out of two DIMMs 111 and 112. Output data blocks of the first DIMM 111 are directed to a first data checking circuit 132a to check their ECC bits. When no error is found, the first data checking circuit 132a forwards these data blocks to a buffer selector circuit 132c. The buffer selector circuit 132c selects to which buffer to enter the received data blocks. For example, the buffer selector circuit 132c checks the number of mounted DIMMs by consulting the register array 131a. When there are two DIMMs as in FIG. 6, the buffer selector circuit 132c enters every received data block to the first buffer 134a. When the first DIMM 111 is the only DIMM as in FIG. 7, the buffer selector circuit 132c distributes received data blocks to the first buffer 134a and second buffer 135a by turns.

Similarly to the above, output data blocks of the second DIMM 112 are directed to a second data checking circuit 132b in the data saving circuit 132 to check their ECC bits. When no error is found, the second data checking circuit 132b sends the data blocks to the second buffer 135b.

The first buffer 134a is connected to a first write counter 132d and a read counter 132f. The first write counter 132d points to a particular location in the first buffer 134a to which the next data is supposed to be written. Each time the first buffer 134a accepts new data, the first write counter 132d is incremented by the amount of that data. The read counter 132f points to a particular location in the first and second buffers 134a and 135a from which the next data is to be read. Each time some stored data is read out of these buffers 134a and 135a, the read counter 132f is incremented by the amount of that data. It is noted here that every data block in the first and second buffers 134a and 135a is read out twice to duplicate it at two different SSD locations. To implement this feature, the read counter 132f is configured to reverse its count by a value equivalent to one block, upon completion of the first round of reading. The first write counter 132d and the read counter 132f are connected to a counter comparator circuit 132h described later.

The second buffer 135a is connected to a second write counter 132e that points to a particular location to which the next data is supposed to be written. Each time the second buffer 135a accepts new data, the second write counter 132e is incremented by the amount of that data.

The counter comparator circuit 132h checks the vacancy in the first buffer 134a by comparing the first write counter 132d with the read counter 132f. For example, the difference between the first write counter 132d and read counter 132f indicates the amount of unread data in the first buffer 134a. The remaining space in the first buffer 134a is considered to be vacant. When this vacancy is greater than the data block size (e.g., 512 bytes), the counter comparator circuit 132h sends a read control circuit 132i a signal indicating a permission to read more data from DIMMs.

The read control circuit 132i works in response to a data save command from the SSU control circuit 104. The read control circuit 132i initiates a read operation of data blocks from DIMMs 111 and 112 by, for example, sending a read enable signal to the DIMMs 111 and 112, together with a read address that specifies which data block(s) to read. This read enable signal causes the specified data block(s) to be read out of the DIMMs 111 and 112 and entered to relevant buffers. The read control circuit 132i also controls whether to read subsequent data blocks in the DIMMs 111 and 112 according to the above-noted signal from the counter comparator circuit 132h which indicates that the first buffer 134a has a space for accepting more data blocks.

The output of the first buffer 134a is connected to a third data checking circuit 132j that checks errors in the output data. For example, the third data checking circuit 132j examines ECC errors in a data block read out of the first buffer 134a. When no error is found, the third data checking circuit 132j outputs the data block to a write control circuit 132l. Similarly, the output of the second buffer 135a is connected to a fourth data checking circuit 132k, which examines ECC errors in a data block read out of the second buffer 135a. When no error is found, the fourth data checking circuit 132k outputs the data block to the write control circuit 132l.

The write control circuit 132l controls write operations of data blocks from DIMMs 111 and 112 to SSDs 121 and 122. For example, the write control circuit 132l obtains a boundary address from the foregoing boundary address calculation circuit 131c. The write control circuit 132l then successively writes data blocks read out of the first DIMM 111 into both the first SSD 121 and the second SSD 122, starting from the topmost address of the former and from the obtained boundary address of the latter. The write control circuit 132l also successively writes data blocks read out of the second DIMM 112 into both the first SSD 121 and the second SSD 122, starting from the boundary address of the former and from the topmost address of the latter.

The write control circuit 132l also obtains the total storage capacity of DIMMs 111 and 112 from the DIMM capacity calculation circuit 131b and uses it to determine whether the data saving process is completed. More specifically, the write control circuit 132l detects completion of a data saving process when the amount of saved data reaches the total storage capacity of DIMMs 111 and 112.

Placed between the write control circuit 132l and first SSD 121 is a first CRC generator circuit 132m. This first CRC generator circuit 132m generates a CRC code for a data block and appends it thereto before the block is sent to the first SSD 121. The data block is thus written to the first SSD 121 together with its CRC code. Similarly, a second CRC generator circuit 132n is placed between the write control circuit 132l and second SSD 122. This second CRC generator circuit 132n generates a CRC code for a data block and appends it thereto before the data block is sent to the second SSD 122. The data block is thus written to the second SSD 122 together with its CRC code.

An example of the memory control circuit 130 of FIG. 10 has been explained above. It is noted that the lines interconnecting functional blocks in FIG. 10 represent some of their communication paths. The person skilled in the art would appreciate that there may be other communication paths in actual implementations.

The following description now elaborates a procedure of saving data in the case of a dual DIMM configuration. It is assumed that the number and capacity of DIMMs are determined at the time of startup of the SSU 100 and not to change thereafter. The memory control circuit 130 stores these parameters in its local registers.

The data saving process is implemented as a combination of two kinds of operations. One is to read data blocks out of DIMMs 111 and 112 and load them into buffers 134a and 135a, and the other is to unload data blocks from these buffers 134a and 135a and write them into SSDs 121 and 122. With reference to FIGS. 11 and 12, each of these operations will be described in detail below.

FIG. 11 is a flowchart illustrating an example of DIMM data read operations according to the second embodiment. Each box seen in FIG. 11 is described below in the order of step numbers.

(Step S101) When the external power supply 21 goes down, the UPS control circuit 102 detects it and notifies the SSU control circuit 104 of the power failure event, besides activating the UPS 103 to supply power to the SSU 100. In response to this notification, the SSU control circuit 104 sends a data save command to the memory control circuit 130, thereby initiating a process of saving data from DIMMs 111 and 112 to SSDs 121 and 122.

(Step S102) The read control circuit 132i determines whether there is a sufficient amount of buffer vacancy for storing data blocks. For example, the read control circuit 132i calculates the amount of remaining space in the first buffer 134a by comparing the first write counter 132d and read counter 132f. When the remaining space is large enough for the first buffer 134a to accept a new data block, the read control circuit 132i advances to step S103. When the remaining space is too small for the same, the read control circuit 132i repeats step S102 until the first buffer 134a regains vacancy.

(Step S103) The read control circuit 132i reads one data block out of each DIMM 111 and 112. Specifically, one data block is read out of the first DIMM 111 and sent to the first data checking circuit 132a. Another data block is read out of the second DIMM 112 and sent to the second data checking circuit 132b.

(Step S104) The first and second data checking circuits 132a and 132b check their respective data blocks to determine whether they have uncorrectable errors. If an uncorrectable ECC error (e.g., multiple-bit error) is detected, the first and second data checking circuits 132a and 132b forcibly close the current process. When no errors are found, the first and second data checking circuits 132a and 132b advance to step S105. Even if a data block exhibits an ECC error, the ECC mechanism may be able to correct the error. When this is the case (e.g., in the case of a single-bit error), the pertinent data checking circuit 132a and 132b corrects the ECC error and advances to step S105.

When the current DIMM data read operation is forcibly closed due to an uncorrectable ECC error, the memory control circuit 130 requests the SSU control circuit 104 to terminate the data saving process. In response, the SSU control circuit 104 stops all functions of the SSU 100, including power supply from the UPS 103.

(Step S105) Since no ECC error is detected, or since a detected error has been corrected, the read control circuit 132i loads the first and second buffers 134a and 135a with the data blocks read at step S103. For example, the data block read out of the first DIMM 111 is entered to a storage space in the first buffer 134a that is addressed by the first write counter 132d. The data block read out of the second DIMM 112 is entered to a storage space in the second buffer 135a that is addressed by the second write counter 132e.

(Step S106) The read control circuit 132i determines whether all data blocks have been read from the two DIMMs 111 and 112. When all data blocks are read, it marks the end of the DIMM data read operations. When there are more data blocks to read, the read control circuit 132i goes back to step S102.

The above-described process flow permits the memory control circuit 130 to repeat reading data blocks from the DIMMs 111 and 112 until all the DIMM data content is read. While all the data blocks in DIMMs are read in the above example, it is possible to modify the embodiment to read a variable amount of data from the DIMMs 111 and 112.

The data unloaded from the first and second buffers 134a and 135a is now written into SSDs 121 and 122. FIG. 12 is a flowchart illustrating an example of SSD data write operations according to the second embodiment. Each box seen in FIG. 12 is described below in the order of step numbers.

(Step S111) The write control circuit 132l determines whether the first and second buffers 134a and 135a contain any data to write. For example, the write control circuit 132l may be configured to interact with the counter comparator circuit 132h to receive its comparison result indicating whether the first write counter 132d and read counter 132f have any difference in their values. If there is such a difference, it means that the first and second buffers 134a and 135a contain some data to write, and the write control circuit 132l thus proceeds to step S112. Step S111 is repeated until some data is found in the first and second buffers 134a and 135a.

(Step S112) The write control circuit 132l reads data out of the first and second buffers 134a and 135a. For example, one data block is read out of each buffer 134a and 135a, and more particularly, from an address space that is pointed by the read counter 132f. The data blocks read out of the first and second buffers 134a and 135a are entered to their corresponding data checking circuits 132j and 132k. The read counter 132f is incremented by a value equivalent to the amount of read data (one data block in the present context).

(Step S113) The third and fourth data checking circuits 132j and 132k determine whether the entered data blocks have any uncorrectable errors. When an uncorrectable ECC error (e.g., multiple-bit error) is detected in one data block, the pertinent data checking circuit 132j and 132k forcibly closes the current process. When no error is found in both data blocks, the data checking circuits 132j and 132k advance to step S114. Even if a data block exhibits an ECC error, the ECC mechanism may be able to correct that error. When this is the case (e.g., in the case of a single-bit error), the pertinent data checking circuit 132j and 132k corrects the ECC error and advances to step S114.

When the current SSD data write operation is forcibly closed due to an uncorrectable ECC error, the memory control circuit 130 requests the SSU control circuit 104 to terminate the data saving process. In response, the SSU control circuit 104 stops all functions of the SSU 100, including power supply from the UPS 103.

(Step S114) The write control circuit 132l writes the output data of the first and second buffers 134a and 135a to SSDs 121 and 122. For example, the write control circuit 132l has two data blocks to write, one read out of the first DIMM 111 and the other read out of the second DIMM 112. The write control circuit 132l writes the former data block, together with its CRC code generated by the first CRC generator circuit 132m, into an address space pointed by a write counter (not illustrated) of the first SSD 121. Similarly, the latter data block is written together with its CRC code generated by the second CRC generator circuit 132n into an address space pointed by a write counter (not illustrated) of the second SSD 122. The write counter of the first SSD 121 is incremented by the amount of data that has been written thereto, as is that of the second SSD 122.

(Step S115) The write control circuit 132l determines whether both the two block write operations of step S114 are finished. When they are finished, the write control circuit 132l advances to step S116. When they are still in progress, the write control circuit 132l repeats this step S115 to wait for the completion.

(Step S116) The write control circuit 132l decrements the read counter 132f coupled to the first and second buffers 134a and 135a, as well as write counters of the SSDs 121 and 122, by a value equivalent to one block, thereby reversing them back to the previous points.

(Step S117) The write control circuit 132l writes output data of the first and second buffers 134a and 135a again to the SSDs 121 and 122. For example, the write control circuit 132l calculates a write address for the first SSD 121 by adding the boundary address value to the current write counter of that SSD 121. The calculated write address is used to write a data block originally read out of the second DIMM 112 to the first SSD 121. The first CRC generator circuit 132m generates a CRC code for this data block and appends the code to the data block before it is sent to the first SSD 121.

The write control circuit 132l also calculates a write address for the second SSD 122 by adding the boundary address value to the current write counter of that SSD 122. The calculated write address is used to write a data block originally read out of the first DIMM 111 to the second SSD 122. The second CRC generator circuit 132n generates a CRC code for this data block and appends the code to the data block before it is sent to the second SSD 122. The write counter of each SSD 121 and 122 is incremented by a value equivalent to the amount of data that has been written thereto.

The flowchart of FIG. 12 includes steps S111 to S117 as part of its main loop for multiple iterations. A single round of these steps produces redundant copies of two DIMM data blocks in the SSDs 121 and 122, one data block from the first DIMM 111 and the other data block from the second DIMM 112.

(Step S118) The write control circuit 132l determines whether the entire data in the DIMMs 111 and 112 has been saved. For example, the write control circuit 132l compares the SSD write address of one SSD 121 or 122 with the total DIMM capacity calculated by the DIMM capacity calculation circuit 131b. Coincidence of these two values indicates that all data blocks have been saved. When this is the case, the write control circuit 132l closes the SSD data write operations of FIG. 12. When there are more data blocks to save, the write control circuit 132l goes back to step S111.

As can be seen from the above description, steps S111 to S117 are repeated until all data blocks in the DIMMs 111 and 112 are saved as two redundant copies in SSDs 121 and 122. The saved data is arranged in the way described in FIG. 9.

(2) Data Restoration Process

This subsection describes a process of data restoration. FIG. 13 is a timing diagram illustrating an example of a data restoration process according to the second embodiment. The upper part of FIG. 13 illustrates read operations of data blocks from two SSDs 121 and 122 labeled with their respective identifiers “SSD-A” and “SSD-B.” The lower part of FIG. 13 illustrates write operations of data blocks to two DIMMs 111 and 112 labeled with their respective identifiers “DIMM-A” and “DIMM-B.”

Upon starting data restoration, address block A in the first SSD 121 (SSD-A) is read in parallel with address block B in the second SSD 122 (SSD-B). Unless an error is found in the obtained data, a write operation for address block A takes place in the first DIMM 111 (DIMM-A) in parallel with that for address block B in the second DIMM 112 (DIMM-B). These operations restore address blocks A and B in the two DIMMs 111 and 112, respectively. Other data blocks are also read successively from the SSDs 121 and 122 and sent to the DIMMs 111 and 112 in a similar way. This is repeated until the entire capacity of the DIMMs 111 and 112 is loaded with their original data.

The restoration of saved data makes progress as illustrated in FIG. 13 and comes an end when the read operations reach the boundary address (4-GB point) of the first SSD 121 and second SSD 122.

The dual redundancy in the SSDs 121 and 122 protects saved data against errors. That is, the data can be restored from one SSD even if the other SSD is inoperative due to soft errors or block failure. More specifically, the read control circuit 132i discards a 512-byte data block in an SSD when it exhibits a CRC error. For DIMM data restoration, the read control circuit 132i reads this data block again, but from the other SSD that is operational. Although this retry operation takes some amount of time, the proposed SSU 100 completes the restoration process as a whole faster than the conventional restoration processing.

Referring now to FIG. 14, the following description explains how the memory control circuit 130 provides the proposed data restoration functions. FIG. 14 exemplifies a structure of the memory control circuit 130. The illustrated memory control circuit 130 includes a memory configuration management circuit 131 and a data restoration circuit 133 to implement the functions of restoring save data. The memory configuration management circuit 131 has an internal structure that has been described with reference to FIG. 10.

The data restoration circuit 133 includes (among others) a first buffer 134b and a second buffer 135b to temporarily store data blocks read out of SSDs 121 and 122. Placed between the first SSD 121 and the first buffer 134b are a first data checking circuit 133a and a first ECC generator circuit 133f. Similarly a second data checking circuit 133b and a second ECC generator circuit 133g are placed between the second SSD 122 and the second buffer 135b.

The first and second data checking circuits 133a and 133b check the CRC code of each data block read out of the first and second SSDs 121 and 122. If a CRC error is found in a data block, the corresponding data checking circuit 133a and 133b informs an error information storage circuit 133c of the error event. The first and second data checking circuits 133a and 133b also transfer output data of the SSDs 121 and 122 to the first and second ECC generator circuits 133f and 133g, respectively.

The first ECC generator circuit 133f generates ECC for data blocks read out of the first SSD 121 and appends the generated codes to the data blocks before they are sent to the first buffer 134b. Similarly the second ECC generator circuit 133g generates ECC for data blocks read out of the second SSD 122 and appends the generated codes to the data blocks before they are sent to the second buffer 135b.

The error information storage circuit 133c maintains a record of errors (error information) reported by the data checking circuits 133a and 133b. For example, the error information storage circuit 133c contains the following pieces of information: the identifier of an SSD whose output data was found faulty; a restoration error flag; read and write addresses (error addresses) of faulty data, and an error count. It is noted that the record of error addresses is not changed at the second occurrence of an error in the same SSD, but keeps the address values recorded at the first occurrence. As will be described later, such error information in the error information storage circuit 133c is referenced by a read control circuit 133e. When a new record of error information is added to the error information storage circuit 133c, the read counter of the buffer corresponding to the faulty SSD is incremented by a value equivalent to one block, so that the data restoration process skips the faulty data block in DIMMs.

The illustrated data restoration circuit 133 further includes a restoration data management circuit 133d to manage the ranges of data to be read out of the SSDs 121 and 122, based on the boundary address calculated by the boundary address calculation circuit 131c. The restoration data management circuit 133d receives a write completion notice from first and second write control circuits 133o and 133p each time they write a data block to DIMMs 111 and 112. Based on this notice, the restoration data management circuit 133d determines whether the DIMMs 111 and 112 are loaded with data up to their capacity. When the DIMMs 111 and 112 are fully written, the restoration data management circuit 133d notifies the read control circuit 133e that no more SSD read operations are needed.

The SSD read operations mentioned above are initiated by the read control circuit 133e upon receipt of a data restore command from the SSU control circuit 104. For example, the read control circuit 133e commands the SSDs 121 and 122 to read one data block that begins at an address specified by the restoration data management circuit 133d. During the course of SSD read operations, both SSDs 121 and 122 may experience errors in their output data. Upon seeing such multiple-SSD errors recorded in the error information storage circuit 133c, the read control circuit 133e interrupts the ongoing SSD read operation and notifies the SSU control circuit 104 of the failed read operation. The read control circuit 133e otherwise finishes SSD read operations upon receipt of a completion notice from the restoration data management circuit 133d.

The first buffer 134b is connected to a first write counter 133h and a first read counter 133j. The first write counter 133h points to a particular location in the first buffer 134b to which the next data is supposed to be written. Each time the first buffer 134b accepts new data, the first write counter 133h is incremented by the amount of that data. The first read counter 133j points to a particular location in the first buffer 134b from which the next data is to be read. Each time some stored data is read out of the first buffer 134b, the first read counter 133j is incremented by the amount of the read data. Similarly to the first buffer 134b, the second buffer 135b is connected to a second write counter 133i and a second read counter 133k. The second write counter 133i points to a particular location in the second buffer 135b to which the next data is supposed to be written. Each time the second buffer 135b accepts new data, the second write counter 133i is incremented by the amount of that data. The second read counter 133k points to a particular location in the second buffer 135b from which the next data is read. Each time some stored data is read out of the second buffer 135b, the second read counter 133k is incremented by the amount of the read data.

Data read out of the first buffer 134b is entered to its corresponding third data checking circuit 1331. The third data checking circuit 1331 checks the ECC bits of each data block read out of the first buffer 134b and, if no error is found, forwards the data block to a destination selection circuit 133n. Similarly, data read out of the second buffer 135b is entered to its corresponding fourth data checking circuit 133m. The fourth data checking circuit 133m checks the ECC bits of each data block and, if no error is found, forwards the data block to the destination selection circuit 133n.

The destination selection circuit 133n selects data blocks from either the first buffer 134b or the second buffer 135b and sends them to either the first write control circuit 133o or the second write control circuit 133p. When, for example, two DIMMs are mounted, the destination selection circuit 133n sends data blocks from the first buffer 134b to the first write control circuit 133o, as well as those from the second buffer 135b to the second write control circuit 133p. When only one DIMM is mounted in the SSU 100, the destination selection circuit 133n selects the first buffer 134b and the second buffer 135b alternately and supplies their output data blocks to the first write control circuit 133o.

The first write control circuit 133o receives data blocks from the destination selection circuit 133n and writes them into the first DIMM 111. Each time a received data block is written, the first write control circuit 133o notifies the restoration data management circuit 133d of completion of a single-block write operation. Similarly, the second write control circuit 133p receives data blocks from the destination selection circuit 133n and writes them into the second DIMM 112. Each time a received data block is written, the second write control circuit 133p notifies the restoration data management circuit 133d of completion of a single-block write operation.

An example of the memory control circuit 130 of FIG. 14 has been explained above. It is noted that the lines interconnecting functional blocks in FIG. 14 represent some of their communication paths. The person skilled in the art would appreciate that there may be other communication paths in actual implementations.

The following description elaborates a procedure of restoring data in the case of a dual-DIMM configuration. Specifically, the proposed data restoration process is implemented as a combination of two kinds of operations. One is to read data blocks out of SSDs 121 and 122 and load them into buffers 134b and 135b. The other is to unload data blocks from the buffers 134b and 135b and write them back into DIMMs 111 and 112. With reference to FIGS. 15 to 17, each of these operations will be described in detail below.

FIG. 15 is a flowchart illustrating an example of SSD data read operations according to the second embodiment. Each box seen in FIG. 15 is described below in the order of step numbers.

(Step S131) The read control circuit 133e reads one data block out of each SSD 121 and 122. This is initiated by a data restore command that the SSU control circuit 104 issues upon recovery from power failure, for example. The data blocks read out of the two SSDs 121 and 122 are supplied to their corresponding data checking circuits 133a and 133b.

(Step S132) The data blocks read out of the two SSDs 121 and 122 are entered to their corresponding buffers 134b and 135b. For example, the data block from the first SSD 121 is forwarded to the first ECC generator circuit 133f after its CRC error is checked by the first data checking circuit 133a. The first ECC generator circuit 133f produces ECC for the data block, and the first buffer 134b stores the ECC-protected data block at a storage location pointed by the first write counter 133h. Similarly, the data block from the second SSD 122 is forwarded to the second ECC generator circuit 133g after its CRC error is checked by the second data checking circuit 133b. The second ECC generator circuit 133g produces ECC for the data block, and the second buffer 135b stores the ECC-protected data block at a storage location pointed by the second write counter 133i.

(Step S133) The first and second data checking circuits 133a and 133b determine the presence of a CRC error in their respective data blocks. When a CRC error is detected in a data block, the corresponding data checking circuit 133a or 133b sends the error information to the error information storage circuit 133c and advances the process to step S135. When no error is detected, the process advances to step S134.

(Step S134) The restoration data management circuit 133d determines whether the amount of read data has reached to the storage capacity of DIMMs 111 and 112. For example, the restoration data management circuit 133d tests this condition by comparing the last read address with the total storage capacity of DIMMs calculated by the DIMM capacity calculation circuit 131b.

When the amount of read data has reached the DIMM storage capacity, the restoration data management circuit 133d sends the read control circuit 133e a signal indicating the end of data read operations. In response, the read control circuit 133e closes the current process of reading data from the SSDs 121 and 122. When the DIMM storage capacity has not been reached, the process goes back to step S131 to read more data blocks.

Since the reading speed of SSDs 121 and 122 is slower than the writing speed of DIMMs 111 and 112, the length of buffers 134b and 135b may be as small as two blocks, for example. This buffer length is sufficient for the memory control circuit 130 to sequentially read SSD data up to the boundary address without the need for seeking a vacancy in the buffers. While the present example assumes 512-byte data blocks, the block size of SSD read data may be variable.

(Step S135) When a CRC error is detected by the first data checking circuit 133a, the second data checking circuit 133b, or both, the detected error is recorded in the error information storage circuit 133c. This error information includes, for example, the identifier of a faulty SSD, error count, and read and write addresses. The error information storage circuit 133c also turns on the restoration error flag to signify the occurrence of an error. It is noted that the error information storage circuit 133c records the address of a faulty data block at the first occurrence of an error, but does not update it with the second occurrence of an error in the same SSD. That is, the error information storage circuit 133c maintains the original address recorded at the first occurrence.

(Step S136) The read control circuit 133e determines whether a plurality of SSDs are experiencing an error. When, for example, both the SSDs 121 and 122 exhibit an error, the process advances to step S137. When only one of these SSDs exhibits an error, the process advances to step S138.

(Step S137) The read control circuit 133e terminates the process of data restoration, and issues a restoration failure report to notify the SSU control circuit 104 that the data restoration has been failed.

(Step S138) Since it is found that only one SSD exhibits an error, the error information storage circuit 133c advances the read counter of a buffer corresponding to the faulty SSD by a value equivalent to one block, so that no data read operation is performed on the faulty data block. This also means that no data write operation will take place for the faulty data block in the DIMMs 111 and 112. The process then goes back to step S131.

As can be seen from the above, the data reading process is forcibly closed when data errors are found in multiple SSDs. Otherwise, block read operations are repeated on the SSDs 121 and 122 until the entire DIMM capacity is reached. The next subsection describes in detail how the memory control circuit 130 performs data write operations on DIMMs.

FIG. 16 is a flowchart illustrating an example of DIMM data write operations according to the second embodiment. Each box seen in FIG. 16 is described below in the order of step numbers.

(Step S141) The first and second write control circuits 133o and 133p determine whether their corresponding buffers 134b and 135b each contain a data block to write. When they have data to write, the process advances to step S142. When they have no data to write, the write control circuits 133o and 133p repeat this step S141 to wait for entry of data.

(Step S142) The first and second write control circuits 133o and 133p read a data block from each buffer 134b and 135b. For example, the first write control circuit 133o reads one data block from an address pointed by the first read counter 133j coupled to the first buffer 134b. This data block is then sent to the first write control circuit 133o via the third data checking circuit 1331 and destination selection circuit 133n. The third data checking circuit 1331 checks the presence of ECC errors in the data block. When a found error is a correctable one, the third data checking circuit 1331 corrects it to regain the original data.

Similarly to the above, the second write control circuit 133p reads another data block from an address pointed by the second read counter 133k coupled to the second buffer 135b. This data block is then sent to the second write control circuit 133p via the fourth data checking circuit 133m and destination selection circuit 133n. The fourth data checking circuit 133m checks the presence of ECC errors in the data block. When a found error is a correctable one, the fourth data checking circuit 133m corrects it to regain the original data.

(Step S143) The first and second write control circuits 133o and 133p determine whether the data checking circuits 1331 and 133m have found uncorrectable errors. When an uncorrectable error is found, the process advances to step S144. Otherwise, the process advances to step S145.

(Step S144) The first and second write control circuits 133o and 133p terminate the data restoration process, issuing a restoration failure report to notify the SSU control circuit 104 that the data restoration is failed.

(Step S145) Since no uncorrectable ECC errors are found, the first and second write control circuits 133o and 133p write the data blocks into DIMMs 111 and 112. More specifically, they have two data blocks to write, one from the first SSD 121 and the other from second SSD 122. The first write control circuit 133o writes the former data block to an address space pointed by a write counter (not illustrated) of the first DIMM 111. Similarly, the second write control circuit 133p writes the latter data block to an address space pointed by a write counter (not illustrated) of the second DIMM 112.

(Step S146) The restoration data management circuit 133d determines whether the current process has read data blocks up to the boundary address of each SSD 121 and 122, and whether the current process has written all those data blocks correctly read out of the SSDs 121 and 122. When both of these things are done, the restoration data management circuit 133d advances to step S147. The restoration data management circuit 133d otherwise returns to step S141, so that the above steps S141 to S145 are repeated until all data blocks up to the boundary address in each SSD 121 and 122 are read out and restored in the DIMMs 111 and 112.

(Step S147) The read control circuit 133e tests the restoration error flag in the error information storage circuit 133c. If the restoration error flag is set to ON, the read control circuit 133e advances to step S148. If not, the read control circuit 133e closes the process of DIMM data write operations.

(Step S148) The data restoration circuit 133 is triggered to execute a process of restoration error recovery, the details of which will be described later with reference to FIG. 17. Upon completion of the error recovery, the existing record in the error information storage circuit 133c is erased, and the restoration error flag is reset to zero (indicating no errors). The process of DIMM data write operations is then closed.

The aforementioned restoration error recovery will now be described below. FIG. 17 is a flowchart of a restoration error recovery process according to the second embodiment. Each box seen in FIG. 17 is described below in the order of step numbers.

(Step S151) The read control circuit 133e obtains a write address (error address) that was recorded in the error information storage circuit 133c upon detection of a data error of an SSD. The read control circuit 133e assigns this write address to the write counter of a relevant DIMM 111 or 112.

(Step S152) The read control circuit 133e also obtains an error count from the error information storage circuit 133c to see how many errors were detected with respect to the SSD in question. When the obtained error count indicates two or more errors, it means that the SSD is likely to be defective. The read control circuit 133e thus proceeds to step S157 to read a substitute data block from an error-free SSD. When the error count indicates a single error, the recorded error is likely to be a soft error. Accordingly the read control circuit 133e proceeds to step S153 to remedy the error by reading the same data block again from the SSD in question.

(Step S153) The read control circuit 133e obtains a record of read address from the error information storage circuit 133c. This read address will be used to read data from the SSD.

(Step S154) The read control circuit 133e reads SSD data blocks successively from the read address to the boundary address. The data blocks are subjected to CRC check and ECC protection before they are entered to a buffer.

(Step S155) For each data block read out of the SSD at step S154, the corresponding data checking circuit tests the presence of a CRC error. When a CRC error is detected, the process advances to step S156. When no CRC error is detected, the process proceeds to step S161.

(Step S156) When a CRC error is detected in data blocks read out of the SSD, the data checking circuit records the detected error in the error information storage circuit 133c. For example, the error count corresponding to the identifier of the SSD is changed from one to two. The process then goes back to step S151 to restart the data restoration with this new error count.

(Step S157) When the error count indicates multiple error occurrences, the read control circuit 133e consults the error information storage circuit 133c to obtain a read address recorded at the time of error detection. The read control circuit 133e then adds this error address to the boundary address and assigns the resulting value as the read address for use with an error-free SSD.

(Step S158) The read control circuit 133e reads data blocks in the error-free SSD, successively from the above read address to the boundary address. These data blocks are subjected to CRC check and ECC protection and then entered to a buffer.

(Step S159) For each data block read out of the error-free SSD at step S158, the corresponding data checking circuit tests the presence of a CRC error. When a CRC error is detected, the process advances to step S160. When no CRC error is detected, the process proceeds to step S161.

(Step S160) Since an error is detected even in the SSD that is deemed to be error-free, the read control circuit 133e issues a restoration failure report to the SSU control circuit 104 and thus terminates the restoration error recovery process.

(Step S161) A data block stored in the buffer is read by a write control circuit coupled to that buffer. The data block is subjected to relevant data checking circuits for checking ECC errors.

(Step S162) The write control circuit tests the presence of an uncorrectable error in the output data of the buffer. When an uncorrectable ECC error is detected, the process proceeds to step S160, where the read control circuit 133e issues a restoration failure report to the SSU control circuit 104 and terminates the restoration error recovery process. When no ECC error is detected, the process advances to step S163.

(Step S163) With the absence of uncorrectable ECC errors, the write control circuit writes the data block to its relevant location in a DIMM as pointed by the write counter of that DIMM.

(Step S164) The restoration data management circuit 133d determines whether all the saved data has been restored in the DIMMs 111 and 112. When all the data has been restored, the restoration error recovery process is closed. When there is more data to restore, the process returns to step S161 and repeats steps S160 to S163 until the data restoration is completed. The processing operations described above enable fast restoration of data from dual-redundant SSDs to DIMMs even if an error is encountered in one SSD.

As can be seen from the above explanation, the second embodiment is designed to save data from DIMMs 111 and 112 to SSDs 121 and 122 so as to store a copy of the entire DIMM data in upper areas of the SSDs 121 and 122. Another copy of DIMM data is stored in lower areas of the SSDs 121 and 122, thereby protecting the saved data with dual redundancy. This feature of data saving permits the entire DIMM data to be restored by sequentially reading data only from the upper area of each SSD 121 and 122. In other words, the second embodiment eliminates the need for reading the lower areas of SSDs 121 and 122, thus making the data restoration more efficient.

For example, let the second embodiment be compared with another possible implementation in which the data blocks are saved into SSDs in the order that they are read out of DIMMs. FIG. 18 illustrates an example of data saving and data restoration processes for comparison with the second embodiment. In this example of FIG. 18, data blocks are read out of two DIMMs 118 and 119 successively from their topmost locations. Both SSDs 128 and 129 receive and store these data blocks in the order that they are read out of the DIMMs 118 and 119, thus producing two copies of DIMM data for dual-redundant protection.

A subsequent data restoration process in this case reads the entire data from either or both of the two SSDs 128 and 129. The DIMMs 118 and 119 have a total storage capacity of 8 GB in the example of FIG. 18, and the individual storage capacity of each SSD 128 and 129 is also 8 GB. The data restoration process reads one set of 8-GB data from one SSD 128, for example.

In contrast, the second embodiment stores data in the upper area of each SSD 121 and 122 as seen in FIG. 6. This arrangement of saved data permits the SSU 100 to restore its DIMM data by reading one set of 4-GB data from the first SSD 121 in parallel with another set of 4-GB data from the second SSD 122 and writing them back into their corresponding DIMMs. The second embodiment reduces the time for data restoration by about half.

While it has been assumed that the SSU contains two DIMMs, the above description may also apply to the case of a single DIMM as discussed previously in FIG. 7. To save data from a single DIMM to dual-redundant SSDs, the foregoing buffer selector circuit 132c selects a different one of two buffers each time a data block is read out of a single DIMM, and directs the data block to the selected buffer. That is, data blocks read out of a single DIMM are distributed to two buffers. These data blocks in the buffers are then saved into SSDs in the same way as described above for the dual DIMM configuration. In a data restoration process, the data read out of each SSD is written into its corresponding buffer, and the destination selection circuit 133n performs alternate read operations on the two buffers, so that the two sets of saved data are merged into a single DIMM. Since DIMMs are faster than SSDs, the parallel readout from SSDs contributes to the reduction of data restoration time even in the case of a single DIMM configuration.

### (c) Third Embodiment

This section describes a third embodiment that provides data saving and restoration techniques applicable to the case of, for example, four or more DIMMs and SSDs. The third embodiment assumes that there are an even number of DIMMs and an even number of SSDs. The DIMMs are divided into two groups with equal quantities. Similarly the SSDs are divided into two groups with equal quantities.

The third embodiment employs its own memory control circuit 130-1. The internal structure of this memory control circuit 130-1 is basically similar to the memory control circuit 130 discussed in FIG. 4 for the second embodiment, but includes some additional selection circuits for DIMMs and SSDs. The following description of the third embodiment will use the same reference numerals for the same functional elements described previously in FIGS. 4, 10, and 14. For details of these elements, refer to the description of the second embodiment.

FIG. 19 is a block diagram illustrating an example of data saving functions of a memory control circuit according to the third embodiment. The illustrated circuitry includes a plurality of DIMMs divided into two groups 113 and 114. One DIMM group 113 has an identifier of “DIMM group 0,” and the other DIMM group 114 has an identifier of “DIMM group 1.” Each individual DIMM in these DIMM groups 113 and 114 has its own identification number for local distinctions within a group.

There are also two groups of SSDs in FIG. 19. One SSD groups 123 has an identifier of “SSD group 0,” and the other SSD group 124 has an identifier of “SSD group 1.” Each individual SSD in these SSD groups 123 and 124 has its own identification number for local distinctions within a group. Each SSD in a group offers a part of its storage space to form a combined area that functions similarly to the upper areas 121a and 122a discussed in FIG. 9. Each SSD in a group also offers another part of its storage space to form another combined area that functions similarly to the lower areas 121b and 122b discussed in FIG. 9.

The memory control circuit 130-1 includes, among others, first and second DIMM selection counters 141 and 142, a DIMM selection counter control circuit 143, first and second selection circuits 144 and 145, and a read data quantity calculation circuit 146. These components are activated when reading data from DIMMs.

Specifically, the first DIMM selection counter 141 is a counter that provides an identification number used to select a DIMM in the DIMM group 113 as a source device of data read operations. The second DIMM selection counter 142 is a counter that provides an identification number used to select a DIMM in the DIMM group 114 as another source device of data read operations. The DIMM selection counter control circuit 143 controls the values of these two DIMM selection counters 141 and 142. The first selection circuit 144 selects a DIMM in the DIMM group 113 as a source device of data read operations, according to the identification number provided by the first DIMM selection counter 141. Similarly, the second selection circuit 145 selects a DIMM in the DIMM group 114 as another source device of data read operations, according to the identification number provided by the second DIMM selection counter 142. The read data quantity calculation circuit 146 counts data words read out of a DIMM and determines whether the read data words have amounted to one data block.

The illustrated memory control circuit 130-1 further includes first and second SSD selection counters 151 and 152, an SSD selection counter control circuit 153, third and fourth selection circuits 154 and 155, and a write data quantity calculation circuit 156. These components are activated when writing data into SSDs.

Specifically, the first SSD selection counter 151 is a counter that provides an identification number used to select an SSD in the SSD group 123 as a destination device of data write operations. The second SSD selection counter 152 is a counter that provides an identification number used to select an SSD in the SSD group 124 as another destination device of data write operations. The SSD selection counter control circuit 153 controls the values of these two SSD selection counters 151 and 152. The third selection circuit 154 selects an SSD in the SSD group 123 as a destination device of data write operations, according to the identification number provided by the first SSD selection counter 151. The fourth selection circuit 155 selects an SSD in the SSD group 124 as another destination device of data write operations, according to the identification number provided by the second SSD selection counter 152. The write data quantity calculation circuit 156 counts data words written into an SSD and determines whether the written data words have amounted to one data block.

The data saving process in the above multi-group DIMMs and SSDs follows basically the same course as the one discussed in the foregoing embodiments for dual DIMM and SSD configurations, except that some selection circuits are added to control which DIMMs and SSDs to select from their groups. There are no particular differences between DIMM group 0 and DIMM group 1 in terms of the way of data reading. There are also no particular differences between SSD group 0 and SSD group 1 in terms of the way of data writing.

FIG. 20 is a flowchart illustrating an example of DIMM data read operations according to the third embodiment. Each box seen in FIG. 20 is described below in the order of step numbers.

(Step S201) When the external power supply 21 goes down, the UPS control circuit 102 detects it and notifies the SSU control circuit 104 of the power failure event, besides activating the UPS 103 to supply power to the SSU 100. In response to this notification, the SSU control circuit 104 sends a data save command to the memory control circuit 130-1, thereby initiating a process of saving data from DIMMs in DIMM groups 113 and 114 to SSDs in SSD groups 123 and 124.

(Step S202) The DIMM selection counter control circuit 143 gives initial values to the first DIMM selection counter 141 and second DIMM selection counter 142. For example, the first and second DIMM selection counters 141 and 142 are both initialized to zero, under the assumption that the DIMMs in each DIMM group 113 and 114 are assigned successively increasing identification numbers beginning with zero. This initialization permits the first selection circuit 144 to select a DIMM in one DIMM group 113 whose identification number matches with the first DIMM selection counter 141 and thus make electrical connections between the selected DIMM and the data saving circuit 132. Similarly the second selection circuit 145 selects a particular DIMM in the other DIMM group 114 whose identification number matches with the second DIMM selection counter 142, thus making electrical connections between the selected DIMM and the data saving circuit 132.

Likewise, the SSD selection counter control circuit 153 initializes the first SSD selection counter 151 and second SSD selection counter 152. For example, the two SSD selection counters 151 and 152 are both initialized to zero, under the assumption that the SSDs in each SSD group 123 and 124 are assigned successively increasing identification numbers beginning with zero. This initialization permits the third selection circuit 154 to select an SSD in one SSD group 123 whose identification number matches with the first SSD selection counter 151 and thus make electrical connections between the selected SSD and the data saving circuit 132. Similarly the fourth selection circuit 155 selects a particular SSD in the other SSD group 124 whose identification number matches with the second SSD selection counter 152, thus making electrical connections between the selected SSD and the data saving circuit 132.

(Step S203) Inside the data saving circuit 132, the read control circuit 132i determines whether there is a sufficient amount of buffer vacancy for storing data blocks. See the description of step S102 in FIG. 11 for details.

(Step S204) The read control circuit 132i reads one data block out of the selected DIMM in each DIMM group 113 and 114. The obtained data blocks, one from the DIMM group 113 and the other from DIMM group 114, are then supplied to the first data checking circuit 132a and second data checking circuit 132b, respectively.

(Step S205) The read data quantity calculation circuit 146 keeps track of the amount of data read out of the DIMM group 113 by counting each read data word. The read data quantity calculation circuit 146 determines whether the amount of read data has reached one data block. When one data block is read, the process advances to step S206. Otherwise, the read data quantity calculation circuit 146 repeats this step S205.

(Step S206) Upon readout of a data block, the DIMM selection counter control circuit 143 increments the first and second DIMM selection counters 141 and 142 by one.

(Step S207) The DIMM selection counter control circuit 143 compares the current value of each DIMM selection counter 141 and 142 with the number of DIMMs per group. It is noted that the total number of DIMMs is previously registered in the register array 131a in the memory configuration management circuit 131, so that the DIMM selection counter control circuit 143 can calculate the number of DIMMs per group by dividing this registered total number by two. When both the first and second DIMM selection counters 141 and 142 have reached the number of DIMMs per group, the process advances to step S209. Otherwise, the process advances to step S208.

(Step S208) As the first and second DIMM selection counters 141 and 142 are still below the number of DIMMs per group, the DIMM selection counter control circuit 143 decrements DIMM read counters for the DIMM groups 113 and 114 by a value equivalent to one block. The process then advances to step S210.

(Step S209) The DIMM selection counter control circuit 143 re-initializes the first and second DIMM selection counters 141 and 142 to zero since they have reached the number of DIMMs per group.

The DIMM read counters are incremented by the amount of data that is read, but step S208 cancels that increment of the DIMM read counters. Step S208 is skipped when the two DIMM selection counters 141 and 142 match with the number of DIMMs per group. In other words, the DIMM read counters are allowed to increment their values by a number equivalent to one block when the noted condition of step S207 is met.

(Step S210) Each data checking circuit 132a and 132b in the data saving circuit 132 determines whether the received data block has any uncorrectable errors. When an uncorrectable ECC error (e.g., multiple-bit error) is found, the data checking circuits 132a and 132b forcibly close the current process. When no error is found, or when it is possible to correct a found ECC error, the data checking circuits 132a and 132b advances the process to step S211.

(Step S211) The two read data blocks are entered to their corresponding buffers 134a and 135a since they have no ECC errors or have had their errors corrected. For example, one data block from the DIMM group 113 is entered to an address space in the first buffer 134a that is pointed by the first write counter 132d. The other data block from the DIMM group 114 is entered to an address space in the second buffer 135a that is pointed by the second write counter 132e.

(Step S212) The read control circuit 132i determines whether all DIMM data has been read out of the DIMM groups 113 and 114. When all data has been read, it means the end of the DIMM data read operations. When some data remains unread, the read control circuit 132i goes back to step S203.

Steps S203 to S211 are repeated in this way until the entire DIMM data is read out, during which the buffers in the data saving circuit 132 receive data words successively. When no errors are detected in the DIMM data and the buffer output data, a data write operation is initiated to write data from the buffers to SSDs in the SSD groups 123 and 124. When an error is detected, the data checking circuits issue an error report and forcibly close the process as mentioned previously.

The data in the first and second buffers 134a and 135a is written into SSDs in the SSD groups 123 and 124 as follows. FIG. 21 is a flowchart illustrating an example of SSD data write operations according to the third embodiment. Each box seen in FIG. 21 is described below in the order of step numbers.

(Step S221) The write control circuit 132l determines whether the first and second buffers 134a and 135a contain any data to write. See the description of step S111 in FIG. 12 for details. The process advances to step S222 when such data is present in the first and second buffers 134a and 135a. Step S221 is otherwise repeated while the first and second buffers 134a and 135a are empty.

(Step S222) The write control circuit 132l reads data out of the first and second buffers 134a and 135a. See the description of step S112 in FIG. 12 for details.

(Step S223) Each data checking circuit 132j and 132k determines whether the entered data block has an uncorrectable error. When an uncorrectable ECC error (e.g., multiple-bit error) is detected, the data checking circuits 132j and 132k forcibly close the current process. When no error is found, or when it is possible to correct a found ECC error, the data checking circuits 132j and 132k advance the process to step S224.

(Step S224) The write control circuit 132l writes output data of the first and second buffers 134a and 135a to selected SSDs in the SSD groups 123 and 124. For example, the write control circuit 132l writes a data block from the DIMM group 113 into an SSD that is currently selected from one SSD group 123. The write control circuit 132l also writes a data block from the DIMM group 114 into an SSD that is currently selected from the other SSD group 124.

(Step S225) The write control circuit 132l determines whether the block write operation of step S224 is finished for both SSD groups. When the operation is finished, the write control circuit 132l advances the process to step S226. When the operation is still in progress, the write control circuit 132l repeats this step S225 to wait for the completion.

(Step S226) The write control circuit 132l decrements the read counter 132f for the first and second buffers 134a and 135a, as well as write counters of SSDs, by a value equivalent to one block. That is, a value equivalent to a single data block is subtracted from the counter values.

(Step S227) The write control circuit 132l writes output data of the first and second buffers 134a and 135a to selected SSDs in the SSD groups 123 and 124. For example, the write control circuit 132l calculates a write address for the currently selected SSD in one SSD group 123 by adding the boundary address value to the write counter of that SSD group 123. The calculated write address is used to write a data block originally read out of a DIMM in the DIMM group 114. Similarly, the write control circuit 132l calculates a write address for the currently selected SSD in the other SSD group 124 by adding the boundary address value to the write counter of that SSD group 124. The calculated write address is used to write a data block originally read out of a DIMM in the DIMM group 113.

(Step S228) The write data quantity calculation circuit 156 determines whether the above step S227 has finished two block write operations, one with each of the SSD groups 123 and 124. When both the two data blocks are written, the process advances to step S229. When the write operations are still in progress, this step S228 is repeated.

(Step S229) Upon completion of the block write operations, the SSD selection counter control circuit 153 increments both SSD selection counters 151 and 152 by one.

(Step S230) The SSD selection counter control circuit 153 compares the current value of each SSD selection counter 151 and 152 with the number of SSDs per group. It is noted that the total number of SSDs is previously registered in the register array 131a in the memory configuration management circuit 131, so that the SSD selection counter control circuit 153 can calculate the number of SSDs per group by dividing this registered total number by two. When both the first and second SSD selection counters 151 and 152 have reached the number of SSDs per group, the process proceeds to step S232. Otherwise, the process advances to step S231.

(Step S231) The SSD selection counter control circuit 153 decrements the write counter of each SSD group 123 and 124 by a value equivalent to one block, since both SSD selection counters 151 and 152 are still below the number of SSDs per group. The process then proceeds to step S233.

(Step S232) The SSD selection counter control circuit 153 initializes each SSD selection counter 151 and 152 to zero, since they have reached the number of SSDs per group.

The SSD write counters are incremented by the amount of data that has been written, but step S231 cancels this increment of the SSD write counters. Step S231 is skipped when the first and second SSD selection counters 151 and 152 match with the number of SSDs per group. In other words, the SSD write counters are allowed to increment their values by a number equivalent to one block when the noted condition of step S230 is met.

(Step S233) The write control circuit 132l determines whether all data in the DIMM groups 113 and 114 has been saved. When all data has been saved, the write control circuit 132l closes the SSD data write operations of FIG. 21. When there is more data to save, the write control circuit 132l goes back to step S221.

As can be seen from the above steps, the memory control circuit 130-1 of the third embodiment is designed to write data into SSD groups 123 and 124 while selecting a destination storage device in each SSD group one by one. The memory control circuit 130-1 maintains the same write address until a predetermined number of data blocks are written in one round of the storage device selection. Each time a single round of such data writing operations is finished, the memory control circuit 130-1 increments the write address by the amount of the data blocks written in that round. This address control technique makes it possible to write data across a plurality of SSDs in each single SSD group.

The above features of the third embodiment enable dual-redundant protection of saved data in a storage system including four or more DIMMs and SSD. That is, the data originally stored in DIMMs in a DIMM group 113 is saved in the upper area of each SSD in one SSD group 123, as well as in the lower area of each SSD in another SSD group 124. Similarly, the data originally stored in DIMMs in another DIMM group 114 is saved in the upper area of each SSD in the latter SSD group 124, as well as in the lower area of each SSD in the former SSD group 123.

The third embodiment restores saved data in the way described below. FIG. 22 is a block diagram illustrating an example of data restoration functions of the memory control circuit according to the third embodiment. The illustrated memory control circuit 130-1 includes, among others, first and second SSD selection counters 161 and 162, an SSD selection counter control circuit 163, first and second selection circuits 164 and 165, and a read data quantity calculation circuit 166. These components are activated when reading data out of SSDs.

Specifically, the first SSD selection counter 161 is a counter that provides an identification number used to select an SSD in one SSD group 123 as a source device of data read operations. The second SSD selection counter 162 is a counter that provides an identification number used to select an SSD in the other SSD group 124 as another source device of data read operations. The SSD selection counter control circuit 163 controls the values of these two SSD selection counters 161 and 162. The first selection circuit 164 selects an SSD in one SSD group 123 as a source device of data read operations, according to the identification number provided by the first SSD selection counter 161. The second selection circuit 165 selects an SSD in the other SSD group 124 as another source device of data read operations, according to the identification number provided by the second SSD selection counter 162. The read data quantity calculation circuit 166 counts data words read out of an SSD and determines whether the read data words have amounted to one data block.

The illustrated memory control circuit 130-1 further includes first and second DIMM selection counters 171 and 172, a DIMM selection counter control circuit 173, third and fourth selection circuits 174 and 175, and a write data quantity calculation circuit 176. These components are activated when writing data into DIMMs.

Specifically, the first DIMM selection counter 171 is a counter that provides an identification number used to select a DIMM in one DIMM group 113 as a destination device of data write operations. The second DIMM selection counter 172 is a counter that provides an identification number used to select a DIMM in the other DIMM group 114 as another destination device of data write operations. The DIMM selection counter control circuit 173 controls the values of these two DIMM selection counters 171 and 172. The third selection circuit 174 selects a DIMM in one DIMM group 113 as a destination device of data write operations, according to the identification number provided by the first DIMM selection counter 171. Similarly, the fourth selection circuit 175 selects a DIMM in the other DIMM group 114 as another destination device of data write operations, according to the identification number provided by the second DIMM selection counter 172. The write data quantity calculation circuit 176 counts data words written into a DIMM and determines whether the written data words have amounted to one data block.

The data restoration process in the above multi-group DIMMs and SSDs follows basically the same course as the one discussed in the foregoing embodiments for dual DIMM and SSD configurations, except that some selection circuits are added to control which DIMMs and which SSDs to select from their groups. There are no particular differences between two SSD groups 0 and 1 in terms of the way of data reading. There are also no particular differences between two DIMM groups 0 and 1 in terms of the way of data writing.

FIG. 23 is a flowchart illustrating an example of SSD data read operations according to the third embodiment. Each box seen in FIG. 23 is described below in the order of step numbers.

(Step S241) The SSD selection counter control circuit 163 gives initial values to its associated SSD selection counters 161 and 162 in response to a data restore command, which the SSU control circuit 104 issues upon recovery from power failure or the like. For example, the first and second SSD selection counters 161 and 162 are both initialized to zero, under the assumption that the SSDs in each SSD group 123 and 124 are assigned successively increasing identification numbers beginning with zero. This initialization permits the first selection circuit 164 to select an SSD in one SSD group 123 whose identification number matches with the first SSD selection counter 161 and thus make electrical connections between the selected SSD and the data restoration circuit 133. Similarly the second selection circuit 165 selects a particular SSD in the other SSD group 124 whose identification number matches with the second SSD selection counter 162, thus making electrical connections between the selected SSD and the data restoration circuit 133.

Likewise, the DIMM selection counter control circuit 173 gives initial values to its associated DIMM selection counters 171 and 172 in response to a data restore command, which the SSU control circuit 104 issues upon recovery from power failure or the like. For example, the first and second DIMM selection counters 171 and 172 are both initialized to zero, under the assumption that the DIMMs in each DIMM group 113 and 114 are assigned successively increasing identification numbers beginning with zero. This initialization permits the third selection circuit 174 to select a DIMM in one DIMM group 113 whose identification number matches with the first DIMM selection counter 171 and thus make electrical connections between the selected DIMM and the data restoration circuit 133. Similarly the fourth selection circuit 175 selects a particular DIMM in the other DIMM group 114 whose identification number matches with the second DIMM selection counter 172, thus making electrical connections between the selected DIMM and the data restoration circuit 133.

(Step S242) The read control circuit 133e in the data restoration circuit 133 reads one data block out of the selected SSD in each SSD group 123 and 124. The obtained data blocks are supplied to their corresponding data checking circuits 133a and 133b.

(Step S243) The data blocks read out of the SSDs in the SSD groups 123 and 124 are entered to their corresponding buffers 134b and 135b.

(Step S244) The read data quantity calculation circuit 166 determines whether the above steps S242 and S243 have finished two block read operations, one with each of the SSD groups 123 and 124. When two blocks are read, the process advances to step S245. When the read operations are still in progress, this step S244 is repeated.

(Step S245) Upon completion of the above data read operations, the SSD selection counter control circuit 153 increments the first and second SSD selection counters 161 and 162 by one.

(Step S246) The SSD selection counter control circuit 163 compares the current value of each SSD selection counter 161 and 162 with the number of SSDs per group. When both the first and second SSD selection counters 161 and 162 have reached the number of SSDs per group, the process proceeds to step S248. Otherwise, the process advances to step S247.

(Step S247) The SSD selection counter control circuit 163 decrements the read counter of each SSD group 123 and 124 by a value equivalent to one block, since both the first and second SSD selection counters 161 and 162 are still below the number of SSDs per group. The process then proceeds to step S249.

The SSD read counters are incremented by the amount of data that is read, but step S247 cancels this increment of the SSD read counters. Step S247 is skipped when the first and second SSD selection counters 161 and 162 match with the number of SSDs per group. In other words, the SSD read counters are allowed to increment their values by a number equivalent to one block when the noted condition of step S246 is met.

(Step S248) The SSD selection counter control circuit 163 initializes each SSD selection counter 161 and 162 to zero, since they have reached the number of SSDs per group.

The above steps S247 and S248 are then followed by steps S249 to S254, which perform the same operations as steps S133 to S138 described in FIG. 15. Steps S242 to S254 are repeated until the entire SSD data is read out, during which the buffers 134b and 135b in the memory control circuit 130-1 receive data words successively. When no uncorrectable errors are detected in the output data of SSD groups 123 and 124 and the buffers, a data write process is initiated to write data from the buffers to DIMMs in DIMM groups 113 and 114. When an error is detected, the data restoration process may be closed forcibly after reporting the error, or may continue with correct data obtained from the redundancy-protected SSDs.

FIG. 24 is a flowchart illustrating an example of DIMM data write operations according to the third embodiment. Each operation in steps S265 to S273 is described below in the order of step numbers. For preceding steps S261 to S264, see the previous description of steps S141 to S144 in FIG. 16.

(Step S265) Since no uncorrectable ECC errors are found in data blocks read out of buffers, the first and second write control circuits 133o and 133p write these data blocks to the currently selected DIMMs in the DIMM groups 113 and 114. For example, the first write control circuit 133o writes a data block from the SSD group 123 into a DIMM that is currently selected from one DIMM group 113. Similarly, the second write control circuit 133p writes a data block from the SSD group 124 into a DIMM that is currently selected from the other DIMM group 114.

(Step S266) The write data quantity calculation circuit 176 determines whether the above step S265 has finished two block write operations, one with each of the DIMM groups 113 and 114. When two data blocks are written, the process advances to step S267. When the block write operations are still in progress, this step S266 is repeated.

(Step S267) Upon completion of the above block write operations, the DIMM selection counter control circuit 173 increments both the first and second DIMM selection counters 171 and 172 by one.

(Step S268) The DIMM selection counter control circuit 173 compares the current value of each DIMM selection counter 171 and 172 with the number of DIMMs per group. When both the first and second DIMM selection counters 171 and 172 have reached the number of DIMMs per group, the process advances to step S270. Otherwise, the process advances to step S269.

(Step S269) The DIMM selection counter control circuit 173 decrements DIMM write counters in the DIMM groups 113 and 114 by a value equivalent to one block, since the first and second DIMM selection counters 171 and 172 are still below the number of DIMMs per group. The process then proceeds to step S271.

(Step S270) The DIMM selection counter control circuit 173 initializes the first and second DIMM selection counters 171 and 172 to zero since they have reached the number of DIMMs per group

The DIMM write counters are incremented by the amount of data that has been written, but step S269 cancels this increment of the DIMM write counters. Step S269 is skipped when both the first and second DIMM selection counters 171 and 172 match with the number of DIMMs per group. In other words, the DIMM write counters are allowed to increment their values by a number equivalent to one block when the noted condition of step S268 is met.

For subsequent steps S271 to S273, see the previous description of steps S146 to S148 in FIG. 16.

As can be seen from the above description, the third embodiment enhances the techniques for saving and restoring data, so that they are applicable to four or more DIMMs and SSDs. Since the saved DIMM data concentrates in the upper area of each SSD, the data restoration process can re-populate the DIMMs with the entire set of original DIMM data by sequentially reading data out of the upper area of SSDs. This means that the data restoration process does not need to read the lower area of SSDs, thus being able to finish the restoration in a shorter time. The proposed techniques contribute to a more efficient data restoration process.

### (d) Fourth Embodiment

This section describes a fourth embodiment which saves DIMM data in a plurality of SSDs as in the other embodiments, but with a unified data arrangement. For example, FIG. 25 illustrates data that is saved and restored according to the fourth embodiment. Referring to FIG. 25, data in one DIMM 111 is temporarily entered to a buffer 134 in the memory control circuit 130-2 before it is saved into SSDs. The data is then sent from the buffer 134 to two SSDs 121 and 122. More particularly, the data from the first DIMM 111 is written to an upper area 121a of the first SSD 121, as well as to an upper area 122a of the second SSD 122, thus saving redundant copies of the DIMM data in these two separate SSDs.

Similarly to the above, data read out of the second DIMM 112 is temporarily entered to another buffer 135 in the memory control circuit 130-2 before it is sent to the SSDs 121 and 122. This data of the second DIMM 112 is written to a lower area 121b of the first SSD 121, as well as to a lower area 122b of the second SSD 122, thus saving redundant copies of the DIMM data in the two separate SSDs.

Restoration of saved data is achieved by transferring two subsets of the data. Specifically, one subset stored in the upper area 121a of the first SSD 121 is read and entered to its corresponding buffer 134 for temporary storage. This data is then sent from the buffer 134 to its corresponding DIMM 111. Similarly, another subset stored in the lower area 122b of the second SSD 122 is read and entered to its corresponding buffer 135 for temporary storage. This data is then sent from the buffer 135 to its corresponding DIMM 112.

As can be seen from the above description, the fourth embodiment restores saved data by reading data out of the upper area 121a of the first SSD 121 and the lower area 122b of the second SSD 122 and writing it to DIMMs 111 and 112. The restoration process is finished in half the time it takes to read data out of the entire storage space of one SSD 121 or 122.

Unlike the preceding embodiments, two SSDs (SSD-A and SSD-B) are populated with data in the same order. The data restoration process of the fourth embodiment is adapted to this difference to maintain the advantage of quick restoration of data.

The data saving process is formed from DIMM data read operations and SSD data write operations. The fourth embodiment includes the same DIMM read operations described in FIG. 11 for the second embodiment. The SSD data write operations in the fourth embodiment are different in part from those described in FIG. 12 for the second embodiment.

FIG. 26 is a flowchart illustrating an example of SSD data write operations according to the fourth embodiment. Steps S301 to S303, S305, S306, and S308 in this flowchart perform the same things as steps S111 to S113, S115, S116, and S118 in FIG. 12. The following description focuses on steps S304 and S307, which are different from their counterparts in FIG. 12.

(Step S304) The write control circuit 132l writes output data of the first and second buffers 134a and 135a to the SSDs 121 and 122. For example, the write control circuit 132l has two data blocks to write, one read out of the first DIMM 111 and the other read out of the second DIMM 112. The write control circuit 132l writes the former data block into a storage space in the first SSD 121 whose address is pointed by the write counter of the first SSD 121. The write control circuit 132l also writes the latter data block into a storage space in the second SSD 122 whose address is determined by adding the boundary address value to the current write counter of the second SSD 122. The write counter of the first SSD 121 is incremented by the amount of data that has been written thereto, as is that of the second SSD 122.

(Step S307) The write control circuit 132l writes again the same output data of the two buffers 134a and 135a to the same SSDs 121 and 122, but with different address offsets. For example, the write control circuit 132l writes the data block from the first DIMM 111 into a storage space in the second SSD 122 whose address is pointed by the write counter of the second SSD 122. The write control circuit 132l also writes the data block from the second DIMM 112 into a storage space in the first SSD 121 whose address is determined by adding the boundary address value to the current write counter of the first SSD 121. The write counter of the first SSD 121 is incremented by the amount of data that has been written thereto, as is that of the second SSD 122.

The data saved in the above way is restored back into DIMMs by reading data from an upper area 121a preceding the boundary address in the first SSD 121, as well as from a lower area 122b beginning at the boundary address in the second SSD 122. The following description explains a data restoration process of the fourth embodiment, assuming that the SSU 100 has the same configuration discussed previously in FIGS. 3, 4, 10, and 14 for the second embodiment.

FIG. 27 is a flowchart illustrating an example of SSD data read operations executed as part of a data restoration process according to the fourth embodiment. Steps S312 to S319 in this flowchart of FIG. 27 perform the same things as steps S131 to S138 in FIG. 15. The following description thus focuses on step S311, which is not present in FIG. 15.

(Step S311) At the start of a data restoration process, the read control circuit 133e in the data restoration circuit 133 (see FIG. 14) assigns the boundary address to the read counter of the second SSD 122 (SSD-B) as a read address for the same. This means that the read operation on the second SSD 122 starts from a data block at the boundary address. The read counter of the first SSD 121 (SSD-A), on the other hand, is initialized to zero, or the smallest address value. Accordingly the read operation on the first SSD 121 starts from a data block at its topmost address.

As described above, the original data in DIMMs 111 and 112 can be restored by reading saved data from the upper area of the first SSD 121, as well as from the lower area of the second SSD 122. While the two SSDs 121 and 122 store data in the same arrangement as seen in FIG. 25, the data restoration process can finish its work in a shorter time by concurrently performing two sequential read operations on different halves of the SSDs 121 and 122.

The data stored in the buffers as a result of the above SSD read operation of FIG. 27 is then written into DIMMs. This DIMM write operation in the fourth embodiment is basically the same as the one discussed in FIG. 16, except for its restoration error recovery called at step S148. The next description explains how the fourth embodiment recovers from restoration errors.

FIG. 28 is a flowchart of a restoration error recovery process according to the fourth embodiment. Steps S321 to S326 and S328 to S334 in FIG. 28 perform the same things as steps S151 to S156 and S158 to S164 in FIG. 17, respectively. The following description focuses on step S327, which is different from its counterpart S157 in FIG. 17.

(Step S327) When the error count indicates the presence of two or more errors, the read control circuit 133e consults the error information storage circuit 133c again to obtain an SSD read address associated with the detected error. The read control circuit 133e uses this error address as a read address for reading data from an error-free SSD.

That is, when an error is detected in output data of one SSD, the missing piece of data can be filled by simply reading the recorded error address in the other SSD. This is possible because both SSDs 121 and 122 contain the same set of saved data in the same data arrangement.

As can be seen from the above description, the fourth embodiment saves data in two SSDs 121 and 122 in the same arrangement, so that two halves of the saved data can be read together from these SSDs 121 and 122 by running two sequential read operations. This feature of the fourth embodiment contributes to an improved efficiency of data restoration.

### (e) Other Embodiments

Various embodiments have been described above. The proposed processing functions of those embodiments may be implemented by using a computer. FIG. 29 exemplifies a hardware configuration of a computer. The illustrated computer 300 is powered by an external power source via a UPS 15. The computer 300 has a CPU 301 to control its entire operation. This CPU 301 is coupled to a plurality of DIMMs 302 and other various devices and interface circuits via a bus 308. The DIMMs 302 serve as primary storage of the computer 300. Specifically, the DIMMs 302 are used to temporarily store at least some of the operating system (OS) programs and application programs that the CPU 301 executes, in addition to other various data objects that it manipulates at runtime.

Peripheral devices and interface circuits on the bus 308 include a plurality of SSDs 303, a graphics processor 304, an input device interface 305, an optical disc drive 306, and a communication interface 307. The SSDs 303 play the role of secondary storage of the computer 300, which store program files and data files of the operating system and applications. Flash memory and other semiconductor memory devices may also be used as secondary storage. The graphics processor 304, coupled to a monitor 11, produces video images in accordance with drawing commands from the CPU 301 and displays them on a screen of the monitor 11. The monitor 11 may be, for example, a cathode ray tube (CRT) display or a liquid crystal display.

The input device interface 305 is connected to input devices such as a keyboard 12 and a mouse 13 and supplies signals from those input devices to the CPU 301. The mouse 13 is a pointing device, which may be replaced with, or used together with other kind of pointing devices such as touchscreen, tablet, touchpad, and trackball. The optical disc drive 306 reads out data encoded on an optical disc 14, by using laser light. The optical disc 14 is a portable data storage medium, the data recorded on which can be read as a reflection of light or the lack of the same. The optical disc 14 may be a digital versatile disc (DVD), DVD-RAM, compact disc read-only memory (CD-ROM), CD-Recordable (CD-R), or CD-Rewritable (CD-RW), for example. The communication interface 307 is connected to a network 10 to exchange data with other computers (not illustrated).

The above hardware platform may be used to realize the processing functions of the embodiments. The same computer platform of FIG. 29 may also be applied to the data management apparatus 1 discussed in the first embodiment. To achieve such implementations, the instructions describing functions of the data management apparatus 1 (FIG. 1) and memory control circuit 130 (FIGS. 3 and 4) are encoded and provided in the form of computer programs. A computer system executes those programs to provide the processing functions discussed in the preceding sections. The programs may be encoded in a computer-readable medium for the purpose of storage and distribution. Such computer-readable media include magnetic storage devices, optical discs, magneto-optical storage media, semiconductor memory devices, and other tangible storage media. Magnetic storage devices include hard disk drives (HDD), flexible disks (FD), and magnetic tapes, for example. Optical disc media include DVD, DVD-RAM, CD-ROM, CD-RW, and others. Magneto-optical storage media include magneto-optical discs (MO), for example. Computer-readable storage media for storing computer programs do not include transitory media such as propagating signals.

Portable storage media, such as DVD and CD-ROM, are used for distribution of program products. Network-based distribution of software programs may also be possible, in which case several master program files are made available on a server computer for downloading to other computers via a network.

For example, a computer stores various software components in its local storage devices, which have previously been installed from a portable storage medium or downloaded from a server computer. The computer executes programs read out of the local storage device, thereby performing the programmed functions. Where appropriate, the computer may execute program codes read out of a portable storage medium, without installing them in local storage devices. Another alternative method is that the computer dynamically downloads programs from a server computer when they are demanded and executes them upon delivery.

It is further noted that the above processing functions may be executed wholly or partly by a digital signal processor (DSP), application-specific integrated circuit (ASIC), programmable logic device (PLD), or other processing device, or their combinations.

Various embodiments have been described above. According to an aspect of those embodiments, the proposed techniques enable efficient restoration of saved data from non-volatile storage devices back to volatile storage devices.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A data management apparatus comprising:
a volatile storage device;
a first non-volatile storage device whose storage space includes first and second continuous areas each being sequentially accessible;
a second non-volatile storage device whose storage space includes third and fourth continuous areas each being sequentially accessible; and
a processor configured to perform a procedure including:
dividing, in response to a first copy command, data in the volatile storage device into a first dataset and a second dataset,
reading the first dataset and second dataset out of the volatile storage device,
writing the first dataset read out of the volatile storage device into the first continuous area and the fourth continuous area, and the second dataset read out of the volatile storage device into the second continuous area and the third continuous area,
reading, in response to a second copy command, the first dataset out of the first continuous area by making sequential access to the first non-volatile storage device, in parallel with the second dataset out of the third continuous area by making sequential access to the second non-volatile storage device, and
writing the first dataset read out of the first continuous area, as well as the second dataset read out of the third continuous area, into the volatile storage device.

2. The data management apparatus according to claim 1, wherein:
the volatile storage device has a specific storage capacity, and each of the first, second, third, and fourth continuous areas has half the storage capacity of the volatile storage device;
the first continuous area is a continuous storage space beginning at a topmost end of the storage space of the first non-volatile storage device;
the second continuous area is a continuous storage space immediately following the first continuous area in the first non-volatile storage device;
the third continuous area is a continuous storage space beginning at a topmost end of the storage space of the second non-volatile storage device;
the fourth continuous area is a continuous storage space immediately following the third continuous area in the second non-volatile storage device;
the writing of the first dataset read out of the volatile storage device includes writing data words of the first dataset successively to the first non-volatile storage device, starting from the topmost end of the storage space thereof, as well as to the second non-volatile storage device while calculating write addresses therefor by adding an address offset equivalent to half the storage capacity of the volatile storage device to write addresses used in writing the data words of the first dataset to the first non-volatile storage device; and
the writing of the second dataset read out of the volatile storage device includes writing data words of the second dataset successively to the second non-volatile storage device, starting from the topmost end of the storage space thereof, as well as to the first non-volatile storage device while calculating write addresses therefor by adding the address offset to write addresses used in writing the data words of the second dataset to the second non-volatile storage device.

3. The data management apparatus according to claim 1, wherein the procedure further comprises:
recording a first address of first faulty data in the first non-volatile storage device, upon detection of an uncorrectable error in the first faulty data during the reading of the first dataset out of the first continuous area of the first non-volatile storage device;
reading data from the second non-volatile storage device to compensate for the uncorrectable error in the first faulty data, by using a read address that is obtained by adding an address offset equivalent to half the storage capacity of the volatile storage device to the recorded first address;
recording a second address of second faulty data in the second non-volatile storage device, upon detection of an uncorrectable error in the second faulty data during the reading of the second dataset out of the third continuous area of the second non-volatile storage device; and
reading data from the first non-volatile storage device to compensate for the uncorrectable error in the second faulty data, by using a read address that is obtained by adding the address offset to the recorded second address.

4. The data management apparatus according to claim 1, wherein:
the volatile storage device is formed from a first memory module and a second memory module;
the first dataset is data in the first memory module, and the second dataset is data in the second memory module; and
the writing of the first and second datasets read out of the first and third continuous areas includes writing the first dataset to the first memory module, and writing the second dataset to the second memory module.

5. The data management apparatus according to claim 1, wherein:
the volatile storage device includes a plurality of memory modules that are divided into a first group of memory modules and a second group of memory modules;
the first data set is data stored in the first group of memory modules, and the second dataset is data stored in the second group of memory modules; and
the writing of the first and second datasets read out of the first and third continuous areas includes writing the first dataset to the first group of memory modules, and writing the second dataset to the second group of memory modules.

6. The data management apparatus according to claim 1, wherein:
the first non-volatile storage device includes a plurality of storage devices;
the first continuous area is a collection of partial storage areas allocated respectively from the plurality of storage devices in the first non-volatile storage device, and the second continuous area is a collection of other partial storage areas allocated respectively from the plurality of storage devices in the first non-volatile storage device;
the second non-volatile storage device includes a plurality of storage devices;
the third continuous area is a collection of partial storage areas allocated respectively from the plurality of storage devices in the second non-volatile storage device, and the fourth continuous area is a collection of other partial storage areas allocated respectively from the plurality of storage devices in the second non-volatile storage device;
the procedure further comprises:
writing data to the first non-volatile storage device or the second non-volatile storage device by successively selecting the storage devices in the first non-volatile storage device or the second non-volatile storage device, writing successive data blocks with a predetermined data size to a particular write address of the successively selected storage devices, and increasing the write address by a value equivalent to the data size of one data block each time one round of the successive selecting and writing is finished;
reading data from the first non-volatile storage device or the second non-volatile storage device by successively selecting the storage devices in the first non-volatile storage device or the second non-volatile storage device, reading data blocks with the predetermined data size from a particular read address of the successively selected storage devices, and increasing the read address by a value equivalent to the data size of one data block each time one round of the successive selecting and reading is finished.

7. The data management apparatus according to claim 1, wherein:
the volatile storage device includes a single memory module;
the reading the first dataset and second dataset includes dividing data in the memory module into a plurality of data blocks with a predetermined data size, successively reading the data blocks out of the memory module from a topmost address thereof, and reconstructing the first dataset and the second dataset by distributing the read data blocks to the first dataset and the second dataset in an alternating fashion; and
the writing the first dataset and second dataset into the volatile storage device includes writing data blocks of the first dataset and data blocks of the second dataset to the volatile storage device in an alternating fashion.

8. The data management apparatus according to claim 1, wherein:
each of the first, second, third, and fourth continuous areas is half as large as the volatile storage device in terms of storage capacity;
the first continuous area is a continuous storage space beginning at a topmost end of the storage space of the first non-volatile storage device;
the second continuous area is a continuous storage space immediately following the first continuous area in the first non-volatile storage device;
the fourth continuous area is a continuous storage space beginning at a topmost end of the storage space of the second non-volatile storage device;
the third continuous area is a continuous storage space immediately following the fourth continuous area in the second non-volatile storage device;
the reading the first dataset and second dataset out of the volatile storage device reads the first dataset in parallel with the second dataset; and
the writing the first dataset and second dataset read out of the volatile storage device includes:
writing data words of the first dataset successively to the first non-volatile storage device, starting from the topmost end of the storage space thereof, as well as writing data words of the second dataset successively to the second non-volatile storage device while calculating write addresses therefor by adding an address offset equivalent to half the storage capacity of the volatile storage device to write addresses used in writing the data words of the first dataset to the first non-volatile storage device; and
writing data words of the first dataset successively to the second non-volatile storage device, starting from the topmost end of the storage space thereof, as well as writing data words of the second dataset to the first non-volatile storage device while calculating write addresses therefor by adding the address offset to write addresses used in writing the data words of the first dataset to the second non-volatile storage device.

9. The data management apparatus according to claim 8, wherein:
the reading the first dataset out of the first continuous area with sequential access begins at a topmost address of the first continuous area which is also a smallest address in the first non-volatile storage device; and
the reading the second dataset out of the third continuous area with sequential access begins at a topmost address of the third continuous area which is equal to the address offset in the second non-volatile storage device.

10. A method of copying data, comprising:
dividing, by a processor in response to a first copy command, data in a volatile storage device into a first dataset and a second dataset;
reading, by the processor, the first dataset and second dataset out of the volatile storage device;
writing, by the processor, the first dataset read out of the volatile storage device into a first continuous area sequentially accessible in a first non-volatile storage device and a fourth continuous area sequentially accessible in a second non-volatile storage device;
writing, by the processor, the second dataset read out of the volatile storage device into a second continuous area sequentially accessible in the first non-volatile storage device and a third continuous area sequentially accessible in the second non-volatile storage device;
reading, by the processor in response to a second copy command, the first dataset out of the first continuous area by making sequential access to the first non-volatile storage device, in parallel with the second dataset out of the third continuous area by making sequential access to the second non-volatile storage device; and
writing, by the processor, the first dataset read out of the first continuous area, as well as the second dataset read out of the third continuous area, into the volatile storage device.

11. A non-transitory computer-readable storage medium storing a program, the program causing a computer to perform a procedure comprising:
dividing, in response to a first copy command, data in a volatile storage device into a first dataset and a second dataset;
reading the first dataset and second dataset out of the volatile storage device;
writing the first dataset read out of the volatile storage device into a first continuous area sequentially accessible in a first non-volatile storage device, and into a fourth continuous area sequentially accessible in a second non-volatile storage device;
writing the second dataset read out of the volatile storage device into a second continuous area sequentially accessible in the first non-volatile storage device, and into a third continuous area sequentially accessible in the second non-volatile storage device;
reading, in response to a second copy command, the first dataset out of the first continuous area by making sequential access to the first non-volatile storage device, in parallel with the second dataset out of the third continuous area by making sequential access to the second non-volatile storage device; and
writing the first dataset read out of the first continuous area, as well as the second dataset read out of the third continuous area, into the volatile storage device.
